(19) United States
(12) Patent Application Publication
(10) Pub. No.: US 2025/0279675 A1
(43) Pub. Date: Sep. 4, 2025

(54) AI-GRID SYSTEM AND METHODS FOR AI-ENABLED, PROGRAMMABLE, RESILIENT, AND NETWORKED MICROGRIDS

(71) Applicant: The Research Foundation for The State University of New York, Albany, NY (US)

(72) Inventors: Peng ZHANG, Jericho, NY (US); Yifan ZHOU, East Setauket, NY (US); Scott A. SMOLKA, Stony Brook, NY (US); Scott D. STOLLER, Stony Brook, NY (US); Xin WANG, Stony Brook, NY (US)

(21) Appl. No.: 19/068,194

(22) Filed: Mar. 3, 2025

Related U.S. Application Data
(60) Provisional application No. 63/561,089, filed on Mar. 4, 2024.

(51) Int. Cl. H02J 13/00; G05B 13/02; H02J 3/00; H02J 3/04; H02J 3/38

(52) U.S. Cl. CPC H02J 13/00028; G05B 13/027; H02J 3/001; H02J 3/04; H02J 3/38; H02J 13/00001; H02J 13/00002; H02J 2203/20

(57) ABSTRACT

AI grid system and method for networked microgrids, including one or more of the following operations: neural reachability for dynamically verifying behavior of the microgrids; neural ordinary differential equations net (ODE-Net) for modeling states of the microgrids; barrier-based neural simplex for assuring runtime safety and control of neural controllers of the microgrids; grid forming for enabling one or more of passivity, stability, and scalability guarantees in the microgrids; active fault management for providing federated learning to active fault management of the microgrids and/or inverter-based resources; neural dynamic state estimation for estimating the states of the microgrids using ODE-Net with application of Kalman filters; traveling wave protection for processing reflected traveling wave signals in time-frequency domain; and integration and operational visualization for providing visualization of an operational status of the grid system and statuses of the associated microgrids, and providing execution and results of execution of the one or more operations.

### CROSS-REFERENCE TO RELATED APPLICATIONS

The present application claims priority to U.S. Provisional Patent Application No. 63/561,089, filed on Mar. 4, 2024, the contents of which are incorporated herein by reference.

### GOVERNMENT SUPPORT

This invention was made with government support under ITE2134840 and ITE2040599 awarded by the National Science Foundation. The government has certain rights in the invention.

### BACKGROUND

### Field

This application relates to microgrids and power distribution grids interconnected with distributed energy resources. More particularly, this application is directed to an AI-Grid system and methods for AI-enabled, programmable, resilient, and networked microgrids.

### Related Art

Rolling blackouts in Texas and California in the past few years signaled that our power infrastructures are vulnerable to weather events and difficult to meet ever-expanding energy demands from our communities. In fact, based on the Federal Government's statistics, “U.S. power customers experienced an average of nearly 5 hours of interruptions in 2019”, with the top-five impacted states ranging from “almost 7 hours in Mississippi to more than 15 hours in Maine”. Cyber-attacks and surging online activities due to the pandemic have also stressed power grids and compromise grid resiliency. Currently, distributed energy resources are increasing interconnected to the power grids. However, today's inverter-based resources have sensitive trip-off or deactivation settings for grid contingencies, meaning a minor or remote fault can lead to a sudden reduction of power generation from distributed energy resources. This implies that distributed energy resource are often not reliable resilience resources for customers and the grids. A typical example is the Odessa Disturbance that occurred in Texas on May 9, 2021—voltage sags initiated by a single-line-to-ground fault at a combined-cycle power plant caused more than 1.1 GW reduction of solar PV and wind generation up to 200 miles away from the fault location.

Meanwhile, microgrids have become a promising new paradigm for electricity resiliency. A microgrid is an autonomous local power grid formed by a collection of power loads, distributed energy resources, and coordinated control. It can flexibly host renewables and energy storages, and operates continuously even without the utility supply. Naturally, microgrids can serve as aggregators and integrators of PV, wind and various grid-edge facilities, such as smart buildings, electric vehicle charging infrastructures and Power-to-X technologies, to provide grid supports and resilience benefits for customers.

Further, if multiple microgrids are interconnected and well controlled, those networked microgrids have the potential to offer much more resilience benefit, and can even help utilities to quickly restore power. Several main challenges, however, have prohibited the wide adoption of networked microgrids: 1) Lack of understanding and control of networked microgrids dynamics; 2) Limited and unscalable analytics to support real-time decision making and control; and 3) Networked microgrids are vulnerable to cyberattacks. Moreover, it is oftentimes prohibitively expensive for a community to build and operate a microgrid. Forming a microgrid requires protection, automation and control (PAC) embedded in expensive hardware facilities. Coping with challenges of renewables and storms demands frequent, expensive retrofitting and forced re-designs of PAC systems.

It is therefore desirable to resolve the aforementioned challenges in providing AI-enabled, resilient networked microgrids (AI-Grid), including a programmable platform that integrates improvements related to reliable modeling and prediction of system states under uncertainty, reachability analysis, formal control, and cybersecurity technologies to enable scalable, self-protecting, autonomic, and resilient microgrids, as well as networked microgrids capable of coordinating many distributed energy systems and serving as backbone infrastructures of smart communities, wherein the microgrids of the AI-Grid platform will be able to achieve decoupled cyber and physical layers, making microgrid control and management software-defined, hardware-independent, thus achieving more affordable, scalable, and configurable microgrids.

### SUMMARY

The following detailed description of various improvements and embodiments will be made in reference to the accompanying drawings. In describing the foregoing improvements and embodiments, explanation about related functions or constructions known in the art are omitted for the sake of clearness in understanding the concepts and avoid obscuring the improvements with unnecessary detail.

Embodiments described herein provide an AI-Grid system and methods for AI-enabled, programmable, resilient, and networked microgrids. The system and methods are directed to an energy management that can monitor, control, and manage microgrids and can be used for planning and design purposes. The system and methods meet urgent demands within our communities to address high electricity-resiliency needs, extreme renewable distributed energy resource (DER) integration issues, and trustworthiness of AI-driven operation of critical infrastructures.

The system and methods are a next generation distribution/microgrid/building management system. The system and methods include advanced fault management control and optimization to enable enhanced DER, EV, and microgrid penetration without compromising reliability. The system and methods feature SDN-base architectures and techniques to enable secure, reliable, and fault-tolerant algorithms for resilient networked systems. The system and methods provide reachability techniques to support provable resilience on the fly, with high penetration of renewables. With the availability of data from smart sensors (sometimes under data-rich, information-poor situations), AI-Grid as a data-intensive, self-configurable management system enables resilient distribution grids, smart communities, and smart infrastructures for EV and DER aggregations.

The system and methods provide the following features and advantages:
Model-free and intelligent situation awareness;
resilient and stable operations;
security assurance;
ultra-timely protection;
modern and user-friendly visualization;
software-defined control;
formal verification; and
fault management/attack localization.

Accordingly, the system and methods are directed to a programmable platform that integrates various deep neural network (DNN) frameworks, provides reliable modeling and prediction of system states under uncertainty, reachability analysis, formal control, and runtime assurance technologies to enable scalable, self-protecting, autonomic and ultra-resilient networked microgrids capable of coordinating ultra-scale DERs and cultivates smart communities.

In accordance with an embodiment, there is disclosed an artificial intelligence (AI) grid system for networked microgrids, wherein the system includes a processing device, and a memory storing instructions that, when executed by the processing device, perform at one or more of the following operations: neural reachability for dynamically verifying behavior of the microgrids; neural ordinary differential equations net (ODE-Net) for modeling states associated with the microgrids; barrier-based neural simplex for assuring runtime safety and control of neural controllers associated with the microgrids; grid forming (GFM^{H}—Hamiltonian grid forming technology) for enabling one or more of passivity, stability, and scalability guarantees in the microgrids; active fault management (AI-AFM) for providing federated learning to active fault management of the microgrids and/or inverter-based resources (IBRs), with cybersecurity assurance against one or more attacks and/or data poisoning; neural dynamic state estimation for estimating the states of the microgrids using ODE-Net with application of Kalman filters; traveling wave protection (AI-TWP) for providing neural network facilitated and internet-of-things (IoT) enabled processing of reflected traveling wave signals in a time-frequency domain; and integration and operational visualization of the one or more operations, providing for visualization of an operational status of the grid system and statuses of the associated microgrids, and providing for execution and results of execution of the one or more operations.

In accordance with another embodiment, there is disclosed an artificial intelligence (AI) grid method for networked microgrids, the method comprising performing one or more of the following operations including: neural reachability for dynamically verifying behavior of the microgrids; neural ordinary differential equations net (ODE-Net) for modeling states associated with the microgrids; barrier-based neural simplex for assuring runtime safety and control of neural controllers associated with the microgrids; grid forming (GFM^{H}—Hamiltonian grid forming technology) for enabling one or more of passivity, stability, and scalability guarantees in the microgrids; active fault management (AI-AFM) for providing federated learning to active fault management of the microgrids and/or inverter-based resources (IBRs), with cybersecurity assurance against one or more attacks and/or data poisoning; neural dynamic state estimation for estimating the states of the microgrids using ODE-Net with application of Kalman filters; traveling wave protection (AI-TWP) for providing neural network facilitated and internet-of-things (IoT) enabled processing of reflected traveling wave signals in a time-frequency domain; and integration and operational visualization of the one or more operations, providing for visualization of an operational status of the grid system and statuses of the associated microgrids, and providing for execution and results of execution of the one or more operations.

Additional embodiments of the system and methods described herein are provided in the detailed description, which is set forth hereinbelow. It should be noted that each of the various improvements can be an embodiment standing on its own, and can similarly be incorporated with other improvements to define further embodiments of the AI-Grid system and methods for AI-enabled, programmable, resilient, and networked microgrids as described herein.

While the system and methods have been shown and described with reference to certain embodiments, it will be understood by those skilled in the art that various changes in from and details may be made therein without departing from the scope of the system and methods, as well as equivalents thereof.

These and other purposes, goals, and advantages of the present application will become apparent from the following detailed description of example embodiments read in connection with the accompanying drawings.

### BRIEF DESCRIPTION OF THE DRAWINGS

Some embodiments are illustrated by way of example and not limitation in the figures of the accompanying drawings in which:

FIG. 1 illustrates a block diagram of an example artificial intelligence (AI) grid associated with autonomic and resilient networked microgrids;

FIG. 2 illustrates an example graphical user interface (GUI) associated with neuro-reachability of the AI grid;

FIG. 3 illustrates an example GUI associated with neuro-dynamic state estimation (NSE);

FIG. 4 illustrates example hardware associated with AI-active fault management (AFM);

FIG. 5 illustrates example hardware associated with AI-traveling wave protection (TWP);

FIG. 6 illustrates an example graph of adversarial graph-gated differential network (AG-GDN) associated with forecasting states of the microgrids;

FIG. 7 illustrates an example graph of a bus system associated with performance evaluation of the microgrids;

FIGS. 8A-8D illustrates predicted DQ current curves in a D-axis of randomly chosen nodes across different cases on the bus system of FIG. 7;

FIG. 9 illustrates a GUI associated with a training progress of the AG-GDN illustrated in FIG. 6;

FIG. 10 illustrates a GUI associated with a testing progress the AG-GDN illustrated in FIG. 6;

FIG. 11 illustrates a block diagram overview of a barrier certificate-based neural simplex architecture (NSA);

FIG. 12 illustrates Lyapunov-function level sets (black-dotted ellipses), barrier certificates (BaC) optimized iteratively (green ellipses), and voltage safety constraints (red lines);

FIG. 13 illustrates an example real-time digital simulator (RTDS) microgrid model;

FIG. 14 illustrates an example integration of external neural controller (NC) with the RTDS model;

FIG. 15 illustrates an example GUI showing information related to neural simplex;

FIG. 16 illustrates example NCs with adversarial inputs, with a left panel without NSA and a right panel with NSA;

FIG. 17 illustrates an example RTDS system architecture;

FIG. 18 illustrates an example software architecture workflow of AI-Grid algorithms, functions, and data manipulation;

FIG. 19 illustrates an example RTDS run-time view of the microgrids in the AI grid.

FIG. 20 illustrates an example GTnet-DNP model associated with transmitting RTDS data;

FIG. 21 illustrates an example graph of encoding/decoding speed performance associated with RTDS data transmission;

FIG. 22 illustrates an example of customized encoding process of the RTDS data;

FIG. 23 illustrates an example of customized decoding process of the RTDS data;

FIG. 24 illustrates an example graph of a speed test using sinewave for encoding and decoding;

FIG. 25 illustrates an example graph of a speed test using a sawtooth wave for encoding and decoding;

FIG. 26 illustrates an example listing of C data access code;

FIG. 27 illustrates an example listing of Python data access code;

FIG. 28 illustrates an example display of database query speed performance;

FIG. 29 illustrates an example software defined control (SDC) architecture;

FIG. 30 illustrates an example SDC test switch turned on, with visualization of power flow of an asset;

FIG. 31 illustrates an example SDC switch turned off switch, with visualization of power flow of an asset;

FIG. 32 illustrates an example powerflow architecture associated with the AI-Grid;

FIG. 33 illustrates a further example powerflow architecture associated with the AI-Grid;

FIG. 34 illustrates an example GUI overview of the AI grid platform (system);

FIG. 35 illustrates an example GUI monitoring view of a load microgrid asset of the AI grid system;

FIG. 36 illustrates an example GUI monitoring view of a bus microgrid asset of the AI grid system;

FIG. 37 illustrates an example GUI view of a powered voltage visualization of the AI grid system;

FIG. 38 illustrates an example GUI of a power flow visualization of the AI grid system; and

FIG. 39 illustrates a block diagram of an example general computer system capable of performing any methods or computer-based functions in accordance with FIGS. 1-38.

### DETAILED DESCRIPTION

### 1. INTRODUCTION

Described herein are an AI-Grid system and associated methods for AI-enabled, programmable, resilient, and networked microgrids. In the following description, for the purposes of explanation, numerous specific details are set forth in order to provide a thorough understanding of example embodiments or aspects. It will be evident, however, to one skilled in the art, that an example embodiment may be practiced without all of the disclosed specific details.

### 2. AI-GRID PLATFORM (SYSTEM)

Introduced herein are AI-Grid system and methods for AI-enabled, programmable, resilient, and networked microgrids, including a programmable platform that integrates improvements related to reliable modeling and prediction of system states under uncertainty, reachability analysis, formal control, and cybersecurity technologies to enable scalable, self-protecting, autonomic, and resilient microgrids, as well as networked microgrids capable of coordinating many distributed energy systems and serving as backbone infrastructures of smart communities, wherein the microgrids of the AI-Grid platform will be able to achieve decoupled cyber and physical layers, making microgrid control and management software-defined, hardware-independent, thus achieving more affordable, scalable, and configurable microgrids.

AI-Grid is a new microgrid management platform that features software-defined-network-based architectures and techniques to enable secure, reliable and fault-tolerant algorithms for resilient networked systems. With the availability of data from smart sensors (sometimes under data rich, information poor situations), AI-Grid can perform various AI-based microgrid operations and monitoring. Work has been performed with end-users to understand their concerns about extreme renewable integration issues, communication delays, data deficiencies, and broadened cyber-attack surfaces. To address the end-user demands, there have been integrated a series of new solutions into the AI-Grid technology, including new features such as neuro-reachability, programmable active security scanning, encrypted control, eigenanalysis for delayed networked microgrids, active fault management, enhanced ODE-Net, and distributed neural Simplex controls.

At the core of AI-Grid are functions such as software-defined microgrid controls for voltage and frequency regulations and three-phase power flow and state estimation algorithms for tracking of operating states of microgrids. A series of model-based and data-driven methods are implemented, which allows us to accurately estimate networked microgrid states under hierarchical control effects, frequent network changes, and network outages. Overlaying on the fundamental modules, a series of AI-enabled functions are incorporated into our platform for enhanced resilience, robustness and assurance guarantees. AI-Grid also offers a user-friendly, expandable 3D user interface. There is work on implementing a mix-integer optimization engine, a zero-trust security framework, and transactive energy functions, and more.

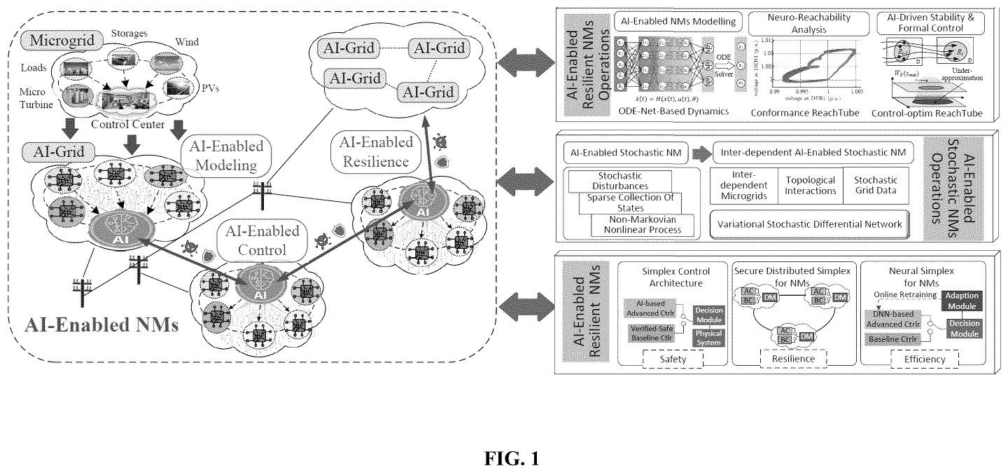

In the following, there are introduced several AI-enabled functions, as summarized in FIG. 1, as well as a software platform of the AI-Grid.

### 3. AI-ENABLED, PROVABLY RESILIENT NM OPERATIONS

Networked microgrids (NMs) are highly susceptible to transient processes initiated by uncertain renewable generation, plug-and-play operations, and grid faults. Hence, verifying NMs' dynamic, stability, and control performance under heterogeneous uncertainties has become critically important. To enable provably resilient NM operations and address the data-rich, information-poor (DRIP) problem, AI-enabled analytics was established for online model discovery, dynamic verification, situational awareness, fault management and protection under various uncertainties and unidentified subsystems.

### 3.1 Neuro-Reachability: AI-Enabled Dynamic Verification of NMs Dynamics

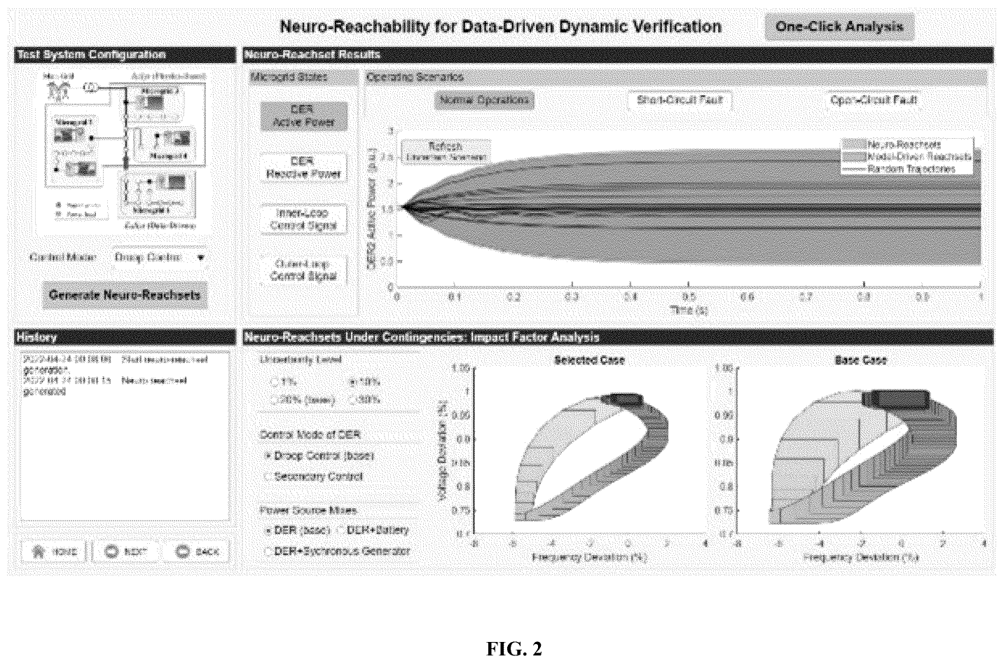

A key innovation of AI-Grid is Neuro-Reachability, i.e., neural ordinary differential equations net (ODE-Net)-enabled reachability methods. Neuro-Reachability (GUI shown in FIG. 2) allows for online dynamic model discovery and data-driven formal verification of NMs dynamics under a wide range of uncertainties.

First, there was devised ODE-Net-enabled dynamic model discovery for networked microgrids (NMs), which can best preserve the continuous-time dynamic behaviors of NMs without assuming any specific dynamic modes. Experiments in 4-microgrid NMs demonstrate the proposed method's accuracy and generalizability. Second, there was developed ODE-Net-based neuro-reachability to formally verify NMs dynamics under inaccessible physics models, uncertain renewables, and unforeseen faults. Reachability analysis is empowered with the conformance theory and use of an optimization approach to estimate the neural model error set. Through experiments, accuracy and conservativeness of the method were verified.

In addition, there is undertaken a process to deploy Reachable power flow (ReachFlow) which can efficiently provide fast state monitoring for NMs even when the operating points have ‘random walks’ driven by renewables and disturbances. Reachable eigenanalysis (ReachEigen) is another reachability tool that can provide small-signal stability for NMs under “random walks” of equilibriums.

### 3.2 Neuro-DSE: AI-Enabled Dynamic State Estimation

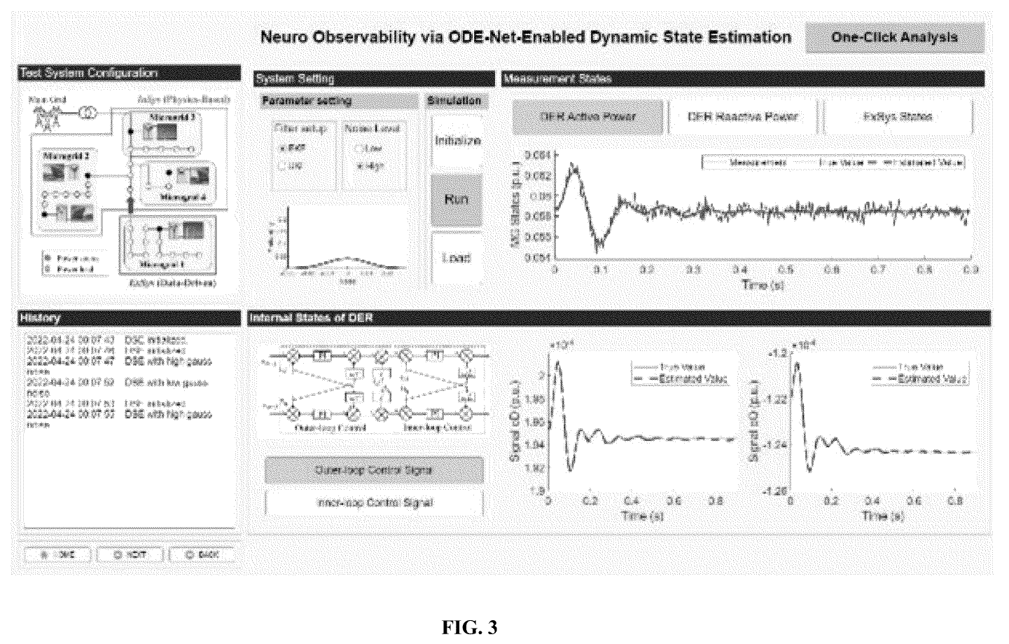

AI-Grid also deploys a novel AI-enabled situational awareness technique, i.e., the ODE-Net-based neural dynamic state estimation (Neuro-DSE). A GUI of Neuro-DSE is shown in FIG. 3. Kalman filters were incorporated into ODE-Net and design a self-refining process to perform ODE-Net training and dynamic state tracking jointly. Simulation validates that neuro-DSE provides satisfactory accuracy even for tracking unobservable states under different sources of noise. Neuro-DSE, therefore, provides a powerful tool for real-time, model-free situational awareness of NMs.

### 3.3 Neural-Adaptability: AI-based Resilient Microgrid Control

Further, AI-Grid deploys a series of learning-based control synthesis and NMs operations to jointly allow for ultra-resilience NMs.

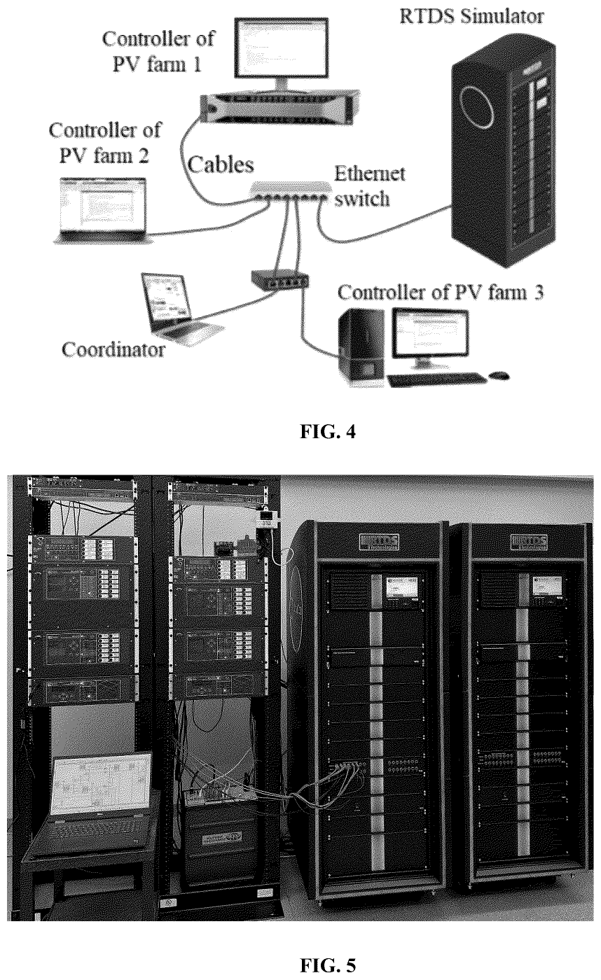

AI-Grid incorporates AI-based active fault management (AI-AFM) to control NMs during faults (hardware testbed shown in FIG. 4). Optimization-based AFM was innovatively replaced with federated-learning-based AFM to meet the real-time needs for coordinating dozens of microgrids. The hardware-in-the-loop (HIL) real-time simulation demonstrates that AI-AFM can output reference values within 10 ms irrespective of the number of microgrids.

Further, AI-based traveling wave protection (AI-TWP) was established to provide ultra-efficacious NM protection (hardware testbed shown in FIG. 5). The Wavelet Kernel Net Convolutional Neural Network (WKN-CNN) is leveraged to accurately and efficiently process the reflected traveling wave signals in the time-frequency domain. The method reports high validation accuracy of 95.83% in a typical 100%-renewable microgrid.

### 4. RESILIENT MODELING & PREDICTION OF NM STATES UNDER UNCERTAINTY

The effective and reliable analysis and control of NMs rely on the accurate modeling and prediction of NM states. Practical NMs as a graph may experience complicated stochastic dynamics over time. The AI modeling of stochastic dynamics is prohibitively difficult due to the uncertain state transitions, sporadic data with possible irregular intervals as a result of loss or data corruption due to reasons such as unreliable communications or device malfunction.

In this section, there are demonstrated new tools for modeling continuous dynamics under partial data and uncertainty. More specifically, to tackle the challenges, the ODE-net was advanced to more flexibly and generally model the nonlinear stochastic dependency among high-dimensional observations with possible irregular data samples. A new continuous-time stochastic predictive model called Adversarial Graph-Gated Differential Network (AG-GDN) is proposed to forecast the microgrid states based on data samples observed at irregular intervals.

### 4.1 Hybrid Neural ODE-SDE Graph Modeling of NM Dynamics

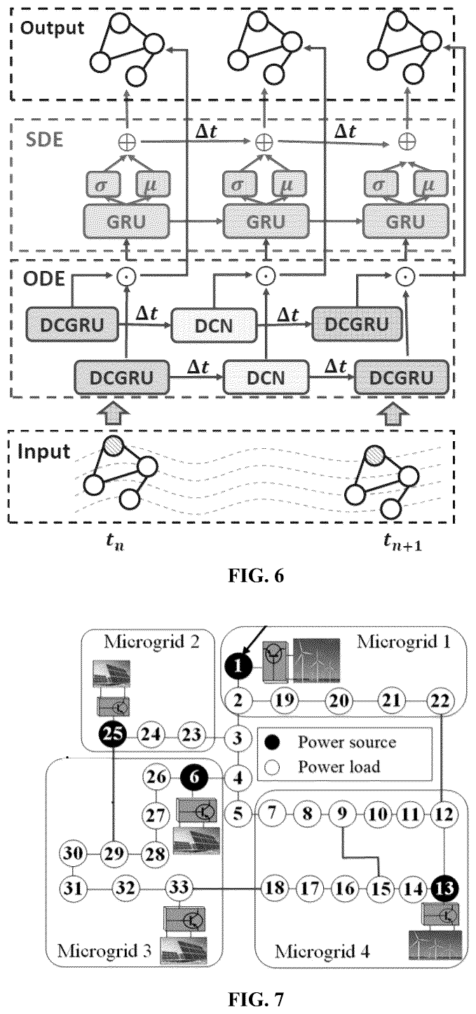

AGGDN effectively learns the continuous graph dynamics from a sequence of spatially and temporally irregular observations of NMs. The model shown in FIG. 6 consists of two major modules: an Ordinary Differential Equation (ODE) to model the topological relationship of microgrid nodes and properties of the microgrid, and a Stochastic Differential Equation (SDE) to capture the process uncertainty. The two modules form the hybrid ODE-SDE structure to evolve simultaneously. Besides, to better adapt to the partial input, there is proposed a soft-masking function in the ODE module, which also provides a soft-mask trajectory to modulate extracted features from irregular observations. As optimizing the model with stochastic terms is difficult, there is a further introduction of a Wasserstein adversarial training objective to efficiently train the model so that it can more scalably and accurately learn the process uncertainty.

Networked microgrid (NM) graph is demonstrated with time-variant signals by [symbol] ={ [symbol] , [symbol] ,{Xₙ, [symbol] ₙ,tₙ}ₙ₌₀^{N}} where [symbol] ={vᵢ [symbol] is the set of microgrid nodes which can be loads or generators and [symbol] = [symbol] is the set of edges (e.g., buses and cables) between nodes. The cardinalities | [symbol] | and | [symbol] | denote the number of elements in [symbol] and [symbol] . Further denoted is the adjacent matrix of a graph as A. In a given NM with the graph topology { [symbol] , [symbol] }, the temporal dynamics are observed as a sequence of N data frames with the d-dimensional time-variant multivariate signals Xₙ∈ [symbol] at time tₙ∈ [symbol] ₊. Signals can be voltages, currents or powers. Since there are often missing samples in real-world systems caused by sensing or transmission problems, in each frame, a mask [symbol] [symbol] ={0, 1 [symbol] is used to indicate the existence of values in the corresponding dimensions. Therefore, the actual observation sequence [symbol] ={Xₙ⊙ [symbol] ₙ}ₙ₌₀^{N} fed into the model is a sporadic time series, possibly with irregular data in both temporal and spatial domains, and ⊙ is an element-wise multiplication.

Given a collection of NM data D={ [symbol] ^{(m)}}ₘ₌₁^{|D|}, i.e., the measurements of NM signals, the objective is to learn a continuous-time recurrent predictive model [symbol] that maximizes the masked log-likelihood:

$${ℒ}_{n} ( 𝒢 ) = {𝔼}_{𝔾 ∈ D} {\sum }_{n = 1}^{N} {ℳ}_{n} ⊗ log {P}_{𝒢} ( {X}_{n} \vert {𝒪}_{0 : n - 1} , {t}_{0 : n} , A ) , \qquad Eq . 1$$

where ⊗ is the sum of element-wise products of two matrices. [symbol] is the model-defined probability density of each element in the feature matrices. To avoid introducing more errors and uncertainty, only the log-likelihood was evaluated in the observed training data indicated by the binary masks.

### 4.2 Neural ODE With Soft-Masking to Adapt to Spatially Partial Observations

The ODE module is applied to extract topological relation and the signal property from the measurements of NMs at discrete points, and embed them into the continuous hidden feature Hₜ∈ [symbol] ,t∈ [symbol] ₊, where dₕ is the dimension of the feature space. There are three functions in the ODE module including: 1) the nonlinear mapping to directly integrate the data information into the hidden feature at the observation time, 2) the differential equation to update the values of hidden feature at the interval of observations, and 3) a soft-masking function for the network to adapt to the positions of missing values. As observations [symbol] ₙ=Xₙ⊙ [symbol] ₙ in each frame n are irregular in the spatial domain with missing values from some nodes, accordingly, the hidden feature Hₜ includes two factors, the feature H_{t,f} that extracts the topological relation and data property, and the masking H_{t,m}∈(0, 1 [symbol] that modulates the values of the feature: where Hₜ=Sigmoid(H_{t,m}Wₘ+bₘ)⊙H_{t,f}, Sigmoid(⋅) denotes the activation function, and {Wₘ,bₘ} are the weight and bias parameters of the auxiliary feed-forward networks.

To parameterize the dynamics of H_{t,f} and H_{t,m} during the interval of the observation time t_{n-1,t}_{ₙ}, ODE is applied with:

$$\frac{{dH}_{t , m}}{dt} = {F}_{m} ( {H}_{t , m} , A ) , \frac{{dH}_{t , f}}{dt} = {F}_{f} ( {H}_{t , f} , A ) , \qquad Eq . 2$$

$$\begin{matrix}{H}_{t , m} = {H}_{{t}_{n - 1} , m} + {\int }_{{t}_{n - 1}}^{t} {F}_{m} ( {H}_{t , m} , A ) dt , \\ {H}_{t , f} = {H}_{{t}_{n - 1} , f} + {\int }_{{t}_{n - 1}}^{t} {F}_{f} ( {H}_{t , f} , A ) dt ,\end{matrix} \qquad Eq . 3$$

where Fₘ(⋅) and F_{f}(⋅) are the first-order derivative for the mask and features, which are computed by the graph neural network.

### 4.3 Neural SDE With Wasserstein Adversarial Training for Efficient Learning of Process Uncertainty

In practical NMs, the observations are influenced by the process uncertainty inside the systems. For instance, the uncertainty in the controlling signal of Distributed Energy Resource (DER) will cause large oscillation in the microgrid current flows. There is introduced the latent state of SDE, a random matrix represented Zₜ∈ [symbol] ,t∈ [symbol] ₊, as to embed the process uncertainty of the underlying dynamics of each node. In order to capture the complicated stochastic process of NMs, the latent state is parameterized by a nonlinear SDE:

$${dZ}_{t} = μ ( {Z}_{t} , {H}_{\leq t} ) dt + σ ( {H}_{\leq t} ) {dB}_{t} , where {Z}_{t} = {Z}_{{t}_{0}} + {\int }_{{t}_{0}}^{t} μ ( {Z}_{t} , {H}_{\leq t} ) dt + {\int }_{{t}_{0}}^{t} σ ( {H}_{\leq t} ) {dB}_{t} , \qquad Eq . 4$$

where μ and σ are the drift and diffusion functions of a SDE. Bₜ denotes the standard Brownian motion. μ is the function of both the current latent state and historical ODE features, but σ will only take the historical ODE features as the input, because including latent state into σ may bring additional noise into the gradient computation to degrade the training process.

Signals of NMs can be predicted with the combination of two components: a trajectory to capture the data evolution trend and a residual term: \hat{X}ₜ=\hat{X}ₜ⁰(Hₜ)+\hat{X}ₜ^{(res)}(Hₜ,Zₜ), where \hat{X}ₜ⁰ is the function of the hidden feature Hₜ to predict the smooth trend of the signal and \hat{X}ₜ^{(res)} further incorporates the latent state Zₜ to estimate the residual term that captures the large variation of signals. ODE features embed the spatial relation of the graph structure, and the SDE component is used to synthesize a latent state trajectory from the ODE features to capture the process uncertainty. A popularly used Gated Recurrent Unit (GRU) can be applied to integrate the historical part of the ODE feature trajectory, with feed-forward networks to take the GRU features to realize the drift and diffusion functions.

With the incorporation of the latent state to capture system uncertainly, both [symbol] (Zₜ_{ₙ}| [symbol] _{0:n-1},A) and the log-likelihood function [symbol] ₗₗ in Eq. 1 will not have closed-form solutions. Rather than simplifying the log-likelihood function and applying a variational inference to obtain an evidence lower bound and the Monte-Carlo method to estimate [symbol] (Zₜ_{ₙ}| [symbol] _{0:n-1},A), given a graph structure with a large number of NM nodes and signals, there is introduced Wasserstein adversarial training to increase the efficiency and the accuracy of learning the proposed model.

### 4.4 Experiments

The effectiveness of each component in the proposed model is demonstrated and the robust performance of the proposed model under different conditions is analyzed through experiments on several microgrid cases. During experiments, the following metrics are mainly evaluated for the comparison between the proposed model and the selected baselines:
Mean Absolute Error (MAE);
Rooted Mean Squared Error (RMSE); and
Mean Absolute Percentage Error (MAPE).

All these metrics are evaluated between the predicted trajectories and the ground-truth, no matter they are observable or not.

IEEE-33 bus system, shown in FIG. 7, is used for performance evaluation. As a typical microgrid instance, it contains 5 electricity sources and 28 load nodes. The 2-dimensional DQ current signals going through each node are generated using a hardware-based tool RTDS produced by [38], the world standard to create real-time data of a power system for hardware-in-the-loop testing of equipment protection and control. To capture the impact of topology diversity and better learn the relationship among nodes, some connections among nodes were randomly cut during generation to form 21 different network structures. For each structure, 50 trajectories were collected with signals sampled at the interval of 3 milliseconds. For each trajectory, the sequence of samples was split into segments of 100 frames for training and testing. Before being fed into the model, all data are normalized with the mean and the standard derivation in the temporal domain of the corresponding node.

TABLE 1
Testing performance of different models on IEEE 33-
Bus System (pₜ = 0.5, pₛ = 0.8).

| | MAE (↓) | RMSE (↓) | MAPE (↓) |
|---|---|---|---|
| Discrete | | | |
| STGCN ([47]) | 0.0812 | 0.1273 | 18.18% |
| GCGRU ([39, 48]) | 0.0349 | 0.0643 | 9.65% |
| Continuous | | | |
| Graph-ODE-RNN ([34]) | 0.0306 | 0.0578 | 8.36% |
| Graph-GRU-ODE ([16]) | 0.0313 | 0.0607 | 8.49% |
| Ours | | | |
| AGGDN | 0.0243 | 0.0457 | 7.03% |

### 4.4.1 Overall Performance

To synthesize the scenario of the sporadic observations, a ratio pₜ of the data frames in the temporal dimension was randomly selected as observed data. For each selected frame, there was assumption that only signals from pₛ of the nodes are observed. Therefore, only pₜ×pₛ fraction of the data are fed into the model, and the data set can be regarded as sparse and also irregular in both temporal and spatial domains due to the random selection. Table 1 shows the performance comparison between the proposed method and some other representative literature works in the case of (pₜ=0.5, pₛ=0.8). From the table, there can be seen that the proposed method has the best performance throughout.

### Continuous Modeling:

From Table 1, it can be seen that no matter the proposed model or other continuous-time models, these models are superior to traditional discrete-time models. Different from discrete models, which only update features at the observation time instants, continuous models make the updates ΔT/δt times between two neighboring observations, where the propagation step δt is much smaller than the sampling interval ΔT (δt=0.1ΔT was set in the experiment). When used with graph convolutions, the integrated information from adjacent nodes will continuously help correct and update the states of the current node. Therefore, even though the simplest Euler-Method is used to approximately calculate the integration, the predicted trajectory fits the original one better than the trajectory provided by the discrete models. Moreover, since the propagation step can be arbitrary small, the continuous-time model can provide predictions at any time to enable timely control, rather than only discretely on observation time points.

### Soft-Masking Function:

There is introduced a soft-masking function to modulate the hidden features in the ODE module for better adapting to the missing data cases. The comparison results in Table 2 have proved the role of such a design.

TABLE 2
Performance comparison of our ODE module with
& without the soft-masking function on IEEE 33-Bus System
(pₜ = 0.5, pₛ = 0.8).

| | MAE (↓) | RMSE (↓) | MAPE (↓) |
|---|---|---|---|
| AGGDN (w/o soft-masking) | 0.0264 | 0.0504 | 7.49% |
| AGGDN (w/soft-masking) | 0.0250 | 0.0471 | 7.21% |

### SDE Module:

To better capture uncertainties existing in all the real-world systems, there is proposed to incorporate stochastic modules, i.e. SDE, in the proposed model. Different from ODE models which make strong Gaussian assumptions about the data distribution, the real distribution is learned by Monte-Carlo sampling process within the SDE propagation. In order to demonstrate the effect of the SDE module, there is also implemented a simplified version, AGGDN(ODE), which does not have the SDE part. The results of the experiments based on both schemes running on the same data are shown in Table 3, and the improvement brought by the SDE module is obvious.

TABLE 3
Performance comparison of our full model
and the simplified model without SDE on IEEE 33-Bus
System (pₜ = 0.5, pₛ = 0.8).

| | MAE (↓) | RMSE (↓) | MAPE (↓) |
|---|---|---|---|
| AGGDN (ODE) | 0.0250 | 0.0471 | 7.21% |
| AGGDN (full) | 0.0243 | 0.0457 | 7.03% |

### Adversarial Training:

Since stochastic terms are incorporated in proposed model, the training process becomes more difficult. To better train the model, there is utilized an adversarial training strategy to avoid the possible gradient explosion problem. For reference, the comparison results are also attached before and after using the adversarial training in Table 4.

TABLE 4
Performance comparison of our model on IEEE 33-Bus System
(pₜ = 0.5, pₛ = 0.8) before & after using adversarial training.

| | MAE (↓) | RMSE (↓) | MAPE (↓) |
|---|---|---|---|
| AGGDN (w/o adversarial | 0.0250 | 0.0473 | 7.20% |
| training) | | | |
| AGGDN (w/adversarial | 0.0243 | 0.0457 | 7.03% |
| training) | | | |

### 4.4.2 Performance in the Presence of Noise

DERs in the microgrid generate powers and transmit them to the whole network. The power system states are affected by the input signals to DERs, which may contain noise in real-world scenarios. The dynamics of sources can be considered as a kind of uncertainties discussed previously. To demonstrate the robustness of the proposed model in dealing with noise and representing the system dynamics, experiments were conducted in the no-missing case and the missing case (pₜ=1.0, pₛ=0.7) separately, with the numerical results given in Table 5.

TABLE 5
Performance of our model on IEEE 33-Bus System with & without
noise on DERs.

| | MAE (↓) | RMSE (↓) | MAPE (↓) |
|---|---|---|---|
| W/O Missing, W/O Noise | 0.0012 | 0.0062 | 1.68% |
| W/Missing, W/O Noise | 0.0040 | 0.0168 | 5.31% |
| W/O Missing, W/Noise | 0.0101 | 0.0189 | 8.69% |
| W/Missing, W/Noise | 0.0203 | 0.0405 | 18.81% |

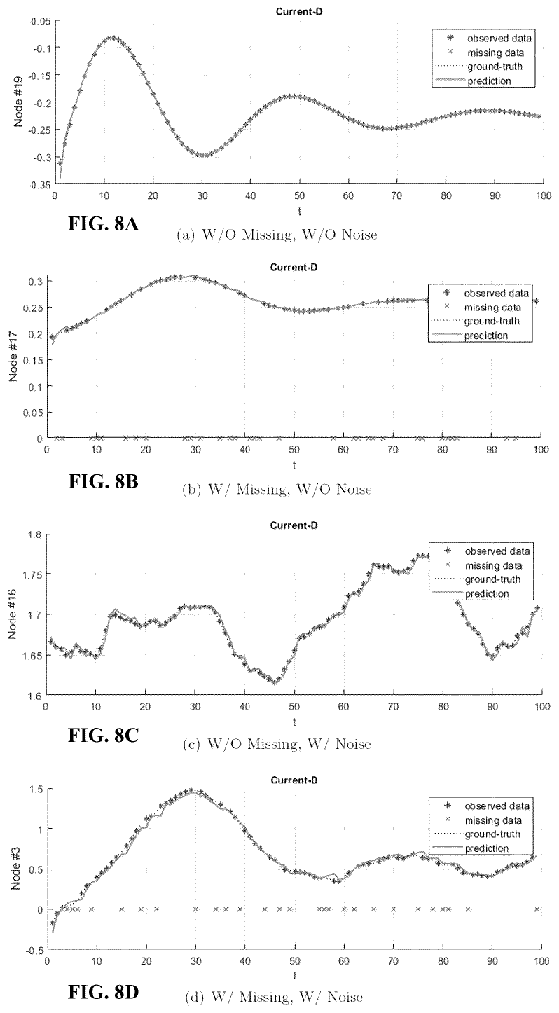

To better illustrate the performance of the model in different cases, some temporal curves are shown in FIGS. 8A-8D. From the table and plots, there can be seen that the noise on DERs only reduces the performance slightly. Since the noise is transmitted to the whole microgrid as well, its effects on different nodes are also correlated.

### 4.4.3 Prototyping

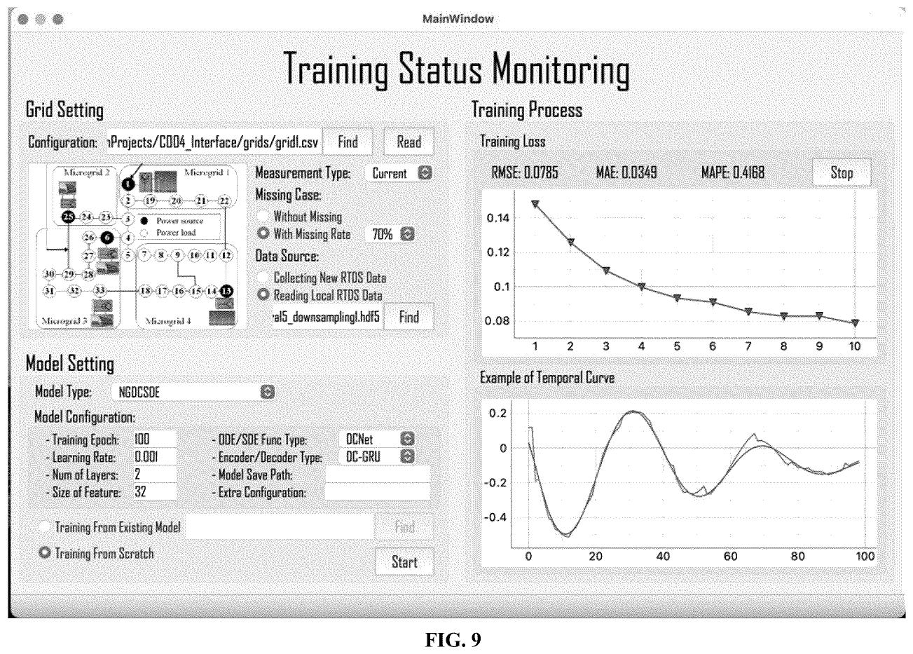

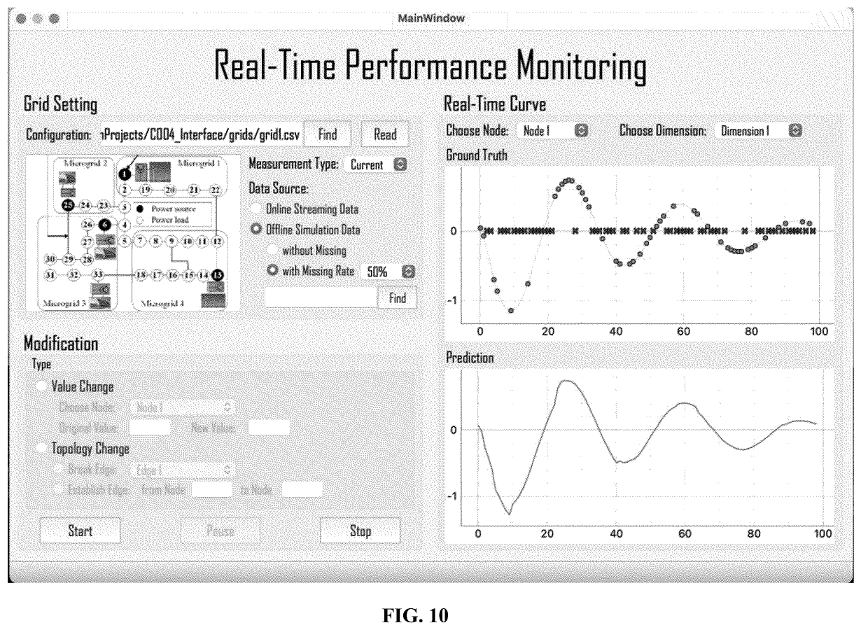

The proposed AGGDN model is further prototyped with two interfaces shown in FIGS. 9 and 10, one for the training and the other for the testing. Users are allowed to flexibly configure testing scenarios. The right panel of the training interface shows the progress of the system over time, including the error between predictions and ground-truth, as well as the randomly chosen example curves of both. The loss between the predicted system states and the true data reduces with the training going, and the curves becomes more and more consistent. On the testing interface, the ground truth data samples are shown on the right panel, with observed samples denoted with green dots while missing ones represented as red “x”s, and the predicted system states are shown as a continuous curve below.

### 5. RUNTIME SAFETY AND SECURITY ASSURANCE FOR AI-GRID

In AI-Grid there is delivered a deployable Three Lines of Defense model that integrates Stony Brook's unique techniques—Neural Simplex Architecture, programmable active security scanning, encrypted control—to enable self-protecting, cyber-physical-resilient, and intelligent NMs. In this section, there is focus on Neural Simplex techniques for runtime safety/security assurance for AI-enabled NMs. The Neural Simplex Architecture is a runtime assurance framework for neural controllers (NCs). There is developed a number of NCs for microgrids, each of which is a DNN trained using the Deep Deterministic Policy Gradient (DDPG) algorithm with the safe-learning strategy of penalizing unrecoverable actions. Through simulations there is demonstrated that the neural controller outperforms traditional droop controllers and generalizes well, and that the decision module and baseline controller ensure safety in the face of errors by the advanced controller.

### 5.1 Introduction

Barrier certificates (BaCs) are a powerful method for verifying the safety of continuous dynamical systems without explicitly computing the set of reachable states. Proving safety of plants with complex controllers, such as AI-based controllers, is difficult with any formal verification technique, including barrier certificates. However, BaCs can play a crucial role in applying the well-established Simplex Control Architecture [40, 41] to provide provably correct runtime safety assurance for systems with complex controllers. It is imperative to have a runtime safety assurance framework for AI-based systems such as the proposed AI-Grid Platform (system), since AI-based controllers, e.g., Deep Neural Networks (DNNs), are difficult to verify and may be vulnerable to adversarial attacks.

This section presents Barrier-based Simplex (Bb-Simplex), a provably correct design for run-time assurance of continuous dynamical systems. Bb-Simplex is part of the AI-Grid Platform. Bb-Simplex is centered around the Simplex Control Architecture, which consists of a high-performance advanced controller (AC) that is not guaranteed to maintain safety of the plant, a verified-safe baseline controller (BC), and a decision module that switches control of the plant between the two controllers to ensure safety without sacrificing performance. In Bb-Simplex, Barrier certificates are used to prove that the baseline controller ensures safety. Furthermore, Bb-Simplex features a new scalable (relative to existing methods that require reachability analysis, e.g., [12, 13, 18]) and automated method for deriving, from the BaC, the conditions for switching between the controllers. The proposed method is based on the Taylor expansion of the BaC and yields computationally inexpensive switching conditions.

Bb-Simplex is demonstrated by applying it to a microgrid modeled in RTDS, an industry-standard high-fidelity, real-time power systems simulator. The microgrid features an advanced controller for PV DER voltage control, in the form of a DNN trained using reinforcement learning. Accordingly, Bb-Simplex is used in conjunction with the Neural Simplex Architecture (NSA) [32], where the AC is an AI-based neural controller (NC). NSA also includes an adaptation module (AM) for online retraining of the NC while the BC is in control. The results demonstrate that Bb-Simplex can automatically derive switching conditions for the AI-Grid system, the switching conditions are not overly conservative, and Bb-Simplex ensures safety even in the presence of adversarial attacks on the neural controller.

### Architectural Overview of Bb-Simplex

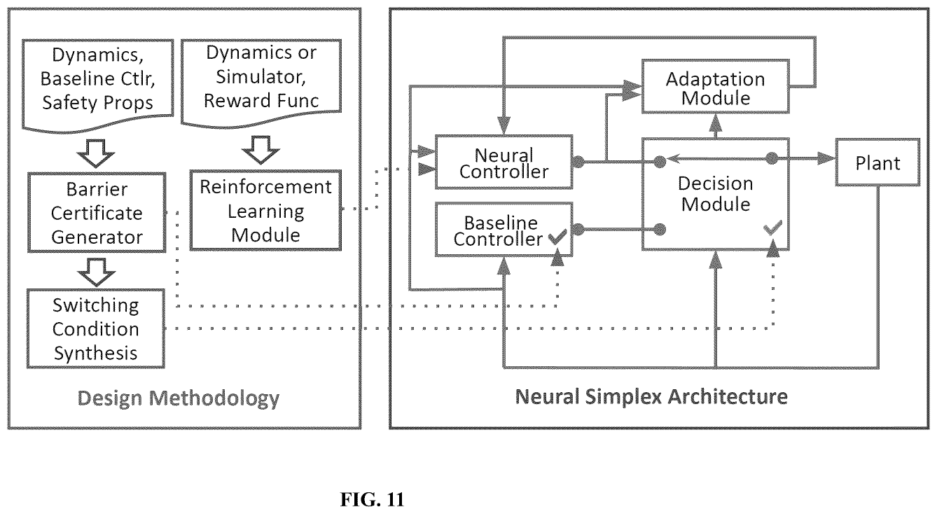

FIG. 11 shows the overall architecture of the combined Barrier-based Neural Simplex Architecture. The green part of the figure depicts proposed design methodology; the blue part illustrates NSA. Given the BC, the required safety properties, and a dynamic model of the plant, the proposed methodology generates a BaC and then derives the switching condition from it. The reinforcement learning module learns a high-performance NC based on the performance objectives encoded in the reward function.

The structure of this section is as follows. Section 5.2 provides background material on barrier certificates. Section 5.3 features the novel approach for deriving switching conditions from barrier certificates. Section 5.4 introduces the microgrid case study and the associated controllers used for microgrid control. Section 5.5 presents the results of the microgrid case study. Sections 5.6 extends the Bb-Simplex framework to handle approximate knowledge of the system dynamics. Section 5.7 extends it to hybrid systems, i.e., systems with multiple modes having different dynamics. Section 5.8 discusses related work.

### 5.2 Preliminaries

Barrier Certificates (BaCs) are used to prove that the BC ensures safety. A BaC is a function of the state satisfying a set of inequalities on the value of the function and value of its time derivative along the dynamic flows of the system. Intuitively, the zero-level-set of a BaC forms a “barrier” between the reachable states and unsafe states. The existence of a BaC assures that starting from a state where the BaC is positive, safety is forever maintained [14, 35, 36]. Moreover, there are automated methods to synthesize BaCs, e.g., [21, 44, 49, 42]. There are implemented two automated methods for BaC synthesis from the literature. As discussed next, one of the methods is based on sum-of-squares optimization (SOS) and the other uses deep learning. The design methodology for computing switching conditions (see Section 5.3) requires a BaC, but is independent of how the BaC is obtained.

### BaC Synthesis Using SOS Optimization

This method first derives a Lyapunov function V for the system using the expanding interior-point algorithm in [11]. It then uses the SOS-based algorithm in [44] to obtain a BaC from V. Note that the largest super-level set of a Lyapunov function within a safety region is a BaC. The algorithm in [21, 44] computes a larger BaC by starting with that sub-level set and then expanding it, by allowing it to take shapes other than that of a sub-level set of the Lyapunov function. This method involves a search of Lyapunov functions and BaCs of various degrees by choosing different candidate polynomials and parameters of the SOS problem. It is limited to systems with polynomial dynamics. In some cases, non-polynomial dynamics can be recast as polynomial using, e.g., the techniques in [11].

### BaC Synthesis Using Deep Learning

There was implementation of SyntheBC from [50], which uses deep learning to synthesize a BaC. First, training samples obtained by sampling different areas of the state space are used to train a feedforward ReLU neural network with two hidden layers as a candidate BaC. Second, the validity of this candidate BaC must be verified. The NN's structure allows the problem of checking whether the NN satisfies the defining conditions of a BaC to be transformed into mixed-integer linear programming (MILP) and mixed-integer quadratically-constrained programming (MIQCP) problems, which were solved using the Gurobi optimizer. If the verification fails, the Gurobi optimizer provides counter-examples which can be used to guide retraining of the NN. In this way, the training and verification steps can be iterated as needed.

### 5.3 Deriving the Switching Condition

A novel methodology was employed to derive the switching logic from the BaC. The Decision Module (DM) implements this switching logic for both forward and reverse switching. When the forward-switching condition (FSC) is true, control is switched from the NC to the BC; likewise, when the reverse-switching condition (RSC) is true, control is switched from the BC to the NC. The success of the proposed approach rests on solving the complex problems discussed in this section to derive an FSC. Consider a continuous dynamical system of the form:

$$\dot{x} = f ( x , u ) \qquad Eq . 5$$

where x∈ [symbol] ^{k} is the state of the plant at time is t and u∈Ω the control input provided to the plant at time t. The set of all valid control actions is denoted by Ω. The set of unsafe states is denoted by [symbol] . Let be x_{lb}, x_{ub}∈ [symbol] ^{k} operational bounds on the ranges of state variables, reflecting physical limits and simple safety requirements.

The set [symbol] of admissible states is given by: [symbol] ={x:x_{lb}≤x≤x_{ub}}. A state of the plant is recoverable if the BC can take over in that state and keep the plant invariably safe. For a given BC, the recoverable region is denoted by [symbol] . Note that [symbol] and [symbol] are disjoint. The safety of such a system can be verified using a BaC h(x): [symbol] ^{k}→ [symbol] of the following form [36, 35, 44, 21]:

$$\begin{matrix}h ( x ) \geq 0 , & ∀ x ∈ {ℝ}^{k} \backslash 𝒰 \\ h ( x ) < 0 , & ∀ x ∈ 𝒰 \\ {( {∇}_{x} h )}^{T} f ( x , u ) + σ ( h ( x ) ) \geq 0 , & ∀ x ∈ {ℝ}^{k}\end{matrix} \qquad Eq . 6$$

where σ(⋅) is an extended class [symbol] function. The BaC is negative over the unsafe region and non-negative otherwise. ∇ₓh is the gradient of h w.r.t x and the expression (∇ₓh)^{T}f(x, u) is the time derivative of h. The zero-super-level set of a BaC h is [symbol] (h)={x:h(x)>0}. In [44], the invariance of this set is used to show [symbol] (h)⊆ [symbol] .

Let η denote the control period a.k.a. time step. Let ĥ(x, u, δ) denote the n^{th}-degree Taylor approximation of BaC h's value after time δ, if control action u is taken in state x. The approximation is computed at the current time to predict h's value δ time units later and is given by:

$$h ( x , u , δ ) = h ( x ) + {\sum }_{i = 1}^{n} \frac{{h}^{i} ( x , u )}{i !} {δ}^{i} \qquad Eq . 7$$

$$\frac{{h}^{n + 1} ( x , u , δ )}{( n + 1 ) !} {η}^{n + 1} for some δ ∈ ( 0 , η ) \qquad Eq . 8$$

where hⁱ(x, u) denotes the i^{th} time derivative of h evaluated in state x if control action u is taken. The control action is needed to calculate the time derivatives of h from the definition of h and Eq. 5 by applying the chain rule. Since there is interest in predicting the value one time step in the future, ĥ(x, u) is used as a shorthand for ĥ(x, u, η). By Taylor's theorem with the Lagrange form of the remainder, the remainder error of the approximation ĥ(x, u) is:

[symbol]

An upper bound on the remainder error, if the state remains in the admissible region during the time interval, is:

$$λ ( u ) = sup \{ \frac{\vert {h}^{n + 1} ( x , u ) \vert}{( n + 1 ) !} {η}^{n + 1} : x ∈ 𝒜 \} \qquad Eq . 9$$

The FSC is based on checking recoverability during the next time step. For this purpose, the set [symbol] of admissible states is shrunk by margins of μ_{dec} and μ_{inc}, a vector of upper bounds on the amount by which each state variable can decrease and increase, respectively, in one time step, maximized over all admissible states. Formally,

$$\begin{matrix}{μ}_{dec} ( u ) = \vert min ( 0 , η {\dot{x}}_{min} ( u ) ) \vert \\ {μ}_{inc} ( u ) = \vert max ( 0 , η {\dot{x}}_{max} ( u ) ) \vert\end{matrix} \qquad Eq . 10$$

where \dot{x}ₘᵢₙ min and \dot{x}ₘₐₓ are vectors of solutions to the optimization problems:

$$\begin{matrix}{\dot{x}}_{i}^{min} ( u ) = inf \{ {\dot{x}}_{i} ( x , u ) : x ∈ 𝒜 \} \\ {x}_{i}^{max} ( u ) = sup \{ {\dot{x}}_{i} ( x , u ) : x ∈ 𝒜 \}\end{matrix} \qquad Eq . 11$$

The difficulty of finding these extremal values depends on the complexity of the functions \dot{x}(x, u). For example, it is relatively easy if they are convex. In the case study of a realistic microgrid model, they are multivariate polynomials with degree 1, and hence convex. The set [symbol] ᵣ of restricted admissible states is given by:

$${𝒜}_{r} ( u0 = \{ x : {x}_{lb} + {μ}_{dec} ( u ) < x < {x}_{ub} - {μ}_{inc} ( u ) \} \qquad Eq . 12$$

Let Reach=_{η}(x, u) denote the set of states reachable from state x after exactly time η if control action u is taken in state x. Let Reach_{≤η}(x, u) denote the set of states reachable from x within time η if control action u is taken in state x.

Lemma 1: For all x∈ [symbol] ᵣ(u) and all control actions u, Reach_{≤η}(x, u)⊆ [symbol] .

Proof. The derivative of x is bounded by \dot{x}ₘᵢₙ(u) and \dot{x}ₘₐₓ(u) for all states in [symbol] . This implies that μ_{dec} and μ_{inc} are bounds on the amounts by which the state x can decrease and increase, respectively, during time η, as long as x remains within [symbol] during the time step. Since [symbol] ᵣ(u) is obtained by shrinking [symbol] by μ_{dec} and μ_{inc} (i.e., by moving the lower and upper bounds, respectively, of each variable inwards by those amounts), the state cannot move outside of [symbol] during time η.

### 5.3.1 Forward Switching Condition

To ensure safety, a forward switching condition (FSC) should switch control from the NC to the BC if using control action u proposed by NC causes any unsafe states to be reachable from the current state x during the next control period, or causes any unrecoverable states to be reachable at the end of the next control period. These two conditions are captured in the following definition:

### Definition 1 (Forward Switching Condition)

Condition FSC(x, u) is a forward switching condition if for every recoverable state x, every control action u, and control period Reach_{≤η}(x, u)∩ [symbol] ≠∅∨Reach_{=η}(x, u) [symbol] [symbol] implies η, FSC(x, u) is true.

Theorem 1: A Simplex architecture whose forward switching condition satisfies Definition 1 keeps the system invariably safe provided the system starts in a recoverable state.

Proof. The definition of an FSC is based directly on the switching logic in Algorithm 1 of [46]. The proof of Theorem 1 in [46] shows that an FSC that is exactly the disjunction of the two conditions in our definition invariantly ensures system safety. It is easy to see that any weaker FSC also ensures safety.

There is now proposed a new and general procedure for constructing a switching condition from a BaC and prove its correctness.

Theorem 2: Given a barrier certificate h, the following condition is a forward switching condition: FSC(x, u)=α∨β where α≡ĥ(x, u)−λ(u)≤0 and β≡x∉ [symbol] ᵣ(u).

Proof. Intuitively, α∨β is an FSC because (1) if condition α is false, then control action u does not lead to an unsafe or unrecoverable state during the next control period, provided the state remains admissible during that period; and (2) if condition β is false, then the state will remain admissible during that period. Thus, if α and β are both false, then nothing bad can happen during the control period, and there is no need to switch to the BC.

Formally, suppose x is a recoverable state, x is a control action, and that Reach_{≤η}(x, u)∩ [symbol] ≠∅∨Reach_{=η}(x, u) [symbol] [symbol] , i.e., there is an unsafe state in Reach_{≤η}(x, u) or an unrecoverable state in Reach_{=η}(x, u). Let x′ denote that unsafe or unrecoverable state. Recall that [symbol] (h)⊆ [symbol] , and [symbol] ∩ [symbol] =∅. Therefore, h(x′, u), ≤0. There is a need to show that α∨β holds. There is performed a case analysis based on whether x is in [symbol] ᵣ(u).

Case 1: x∈ [symbol] ᵣ(u). In this case, a lower bound is used on the value of the BaC h to show that states reachable in the next control period are safe and recoverable. Using Lemma 2.1, Reach_{≤η}(x, u)⊆ [symbol] . This implies that λ(u), whose definition maximizes over x∈ [symbol] , is an upper bound on ĥ(x, u, δ) for δ≤η. This implies that ĥ(x, u)−λ(u) is a lower bound on value of BaC for all states in Reach_{≤η}(x, u). As shown above, there is a state x′ in Reach_{≤η}(x, u) with h(x′, u)≤0. ĥ(x, u)−λ(u) is lower bound on h(x′, u) and hence must also be less than or equal to 0. Thus, α holds.

Case 2: x∉ [symbol] ᵣ(u). In this case, β holds. Note that in this case, the true value of α is not significant (and not relevant, since FSC(x, u) holds regardless), because the state might not remain admissible during the next control period. Hence, the error bound obtained using Eq. 9 is not applicable.

### 5.3.2 Reverse Switching Condition

The RSC is designed with a heuristic approach, since it does not affect safety of the system. To prevent frequent switching between the NC and BC, the RSC is designed to hold if the FSC is likely to remain false for at least m time steps, with m>1. The RSC, like the FSC, is the disjunction of two conditions. The first condition is h(x)≥mη|\dot{h}(x)|, since h is likely to remain non-negative for at least m time steps if its current value is at least that duration times its rate of change. The second condition ensures that the state will remain admissible for m time steps. In particular, take:

$$RSC ( x ) = h ( x ) \geq m η \vert \dot{h} ( x ) \vert ∧ x ∈ {𝒜}_{r , m} , \qquad Eq . 13$$

where the m-times-restricted admissible region is:

$${𝒜}_{r , m} = \{ x : {x}_{lb} + m {μ}_{dec} < x < {x}_{ub} - m {μ}_{inc} \} , \qquad Eq . 14$$

where vectors μ_{dec} and μ_{inc} are defined in the same way as μ_{dec}(u) and μ_{inc}(u) in Eqs. 2.10 and 2.11 except with optimization over all control actions u.

### 5.3.3 Decision Logic

The DM's switching logic has three inputs: the current state x, the control action u proposed by the NC, and the name c of the controller currently in control (as a special case, take c=NC in the first time step). The switching logic is defined by cases as follows: DM(x, u, c) returns BC if c=NC∧FSC(x, u), returns NC if c=BC∧RSC(x), and returns c otherwise.

### 5.4 Application to Microgrids

A microgrid (MG) is an integrated energy system comprising distributed energy resources (DERs) and multiple energy loads. DERs tend to be renewable energy resources and include solar panels, wind turbines, batteries, and emergency diesel generators. By satisfying energy needs from local renewable energy resources, MGs can reduce energy costs and improve energy supply reliability for energy consumers. Some of the major control requirements for an MG are power control, load sharing, and frequency and voltage regulation.

An MG can operate in two modes: grid-connected and islanded. When operated in grid-connected mode, DERs act as constant source of power which can be injected into the network on demand. In contrast, in islanded or autonomous mode, the DERs form a grid of their own, meaning not only do they supply power to the local loads, but they also maintain the MG's voltage and frequency within the specified limits [33]. For the proposed case study, there was focus on voltage regulation in both grid-connected and islanded modes. Specifically, Bb-Simplex was applied to the controller for the inverter for a Photovoltaic (PV) DER.

Applying Bb-Simplex to other DERs which have inverter interfaces such as battery is straight-forward. Of the three controllers necessary for diesel generator DER, the proposed methodology can be applied to voltage and frequency controllers straight-forwardly. The exciter system controls the magnetic flux flowing through the rotor generator, and its dynamics are coupled with that of the diesel engine. There is a plan to explore using the approach presented in [20] to handle these coupled dynamics and apply Bb-Simplex to the exciter system.

### 5.4.1 Baseline Controller

For the experiments, there were used the SOS-based methodology described in Section 5.2 to derive a Barrier Certificate (as a proof of safety) for the baseline controller. A droop controller is used as the BC. A droop controller is a type of proportional controller, traditionally used in power systems for control objectives such as voltage regulation, power regulation, and current sharing [17, 22, 51, 28]. The droop controller tries to balance the electrical power with voltage and frequency. Variations in the active and reactive powers result in frequency and voltage magnitude deviations, respectively. The dynamic model for a voltage droop controller for an inverter has the form \dot{v}−v*+λ_{q}(Q*−Q), where v*, v, Q*, Q are voltage reference, voltage, reactive power reference and reactive power of inverter, respectively, and λ_{q} is the controller's droop co-efficient. Detailed dynamic models for an MG with multiple inverters connected by transmission lines and with droop controllers for frequency and voltage are given in [11, 21].

Consider the following model of an MG's droop-controlled inverters:

$${\dot{θ}}_{i} = {ω}_{i} \qquad Eq . 15 a$$

$${\dot{ω}}_{i} = {ω}_{i}^{0} - {ω}_{i} + {λ}_{i}^{p} ( {P}_{i} - {P}_{i} ) \qquad Eq . 15 b$$

$${\dot{v}}_{i} = {v}_{i}^{0} - {v}_{i} + {λ}_{i}^{q} ( {Q}_{i} - {Q}_{i} ) \qquad Eq . 15 c$$

where θᵢ, ωᵢ, vᵢ are the phase angle, frequency, and voltage of the i^{th} inverter, respectively. Pi and Qi are the inverter's active and reactive power set-points, λ^{p} and λ^{q} are the droop controller's coefficients. The values of set-points Pi and Qi of an inverter depend upon local loads and power needed by the rest of the MG. The loads are not explicitly modeled here. In the case studies, these power set-points were varied to simulate changing loads. Let [symbol] be the set of all inverter indices. The active power Pi and reactive power Qi are given by:

$${P}_{i} = {v}_{i} {\sum }_{j ∈ {𝒩}_{i}} {v}_{k} ( {G}_{i , j} cos {θ}_{i , j} + {B}_{i , j} sin {θ}_{i , j} ) \qquad Eq . 16$$

$${Q}_{i} = {v}_{i} {\sum }_{j ∈ {𝒩}_{i}} {v}_{k} ( {G}_{i , j} sin {θ}_{i , j} - {B}_{i , j} cos {θ}_{i , j} )$$

where θ_{i,j}=θᵢ−θⱼ, and is the set of neighbors of inverter i. G_{i,j} and B_{i,j} are respectively the conductance and susceptance values of the transmission line connecting inverters i and j.

As shown in [11], the stability of such a system can be verified using Lyapunov theory. Detailed dynamic models for an MG with multiple inverters connected by transmission lines and with droop controllers for frequency and voltage are given in [11, 21].

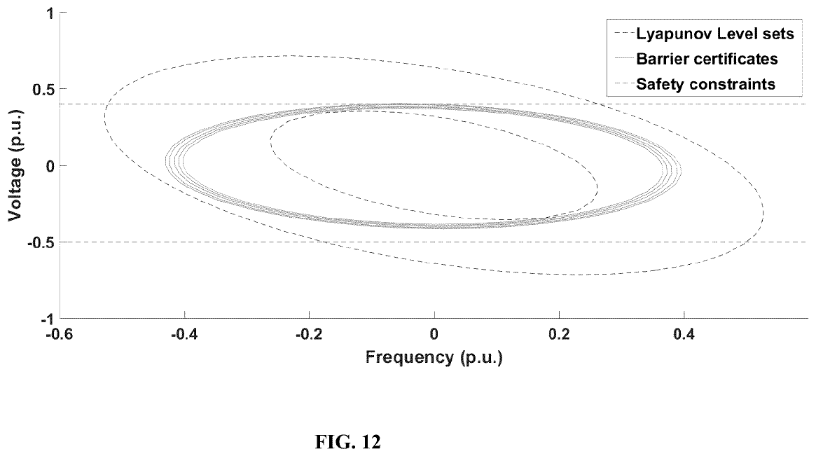

FIG. 12 shows this process of incrementally expanding the Lyapunov function to obtain the BaC. SOS-based algorithms apply only to polynomial dynamics so the droop controller dynamics were recast to be polynomial using a DQ0 transformation to AC waveforms as shown in [30]. This transformation is exact, i.e., it does not introduce any approximation error. In the experimental evaluation (Section 5.5), there were obtained the BaCs for BCs in the form of droop controllers for voltage regulation, in the context of MGs containing up to three DERs of different types. Note that battery DERs operate in two distinct modes, charging and discharging, resulting in a hybrid system model with different dynamics in different modes. For now, there are considered only runs in which the battery remains in the same mode for the duration of the run. Extending the framework to hybrid systems is future work.

### 5.4.2 Neural Controller

To help address the control challenges related to microgrids, the application of neural networks for microgrid control is on the rise as documented in [24]. Increasingly, Reinforcement learning (RL) is being used to train powerful Deep Neural Networks (DNNs) to produce high-performance MG controllers.

Presented is an example approach for learning neural controllers (NCs) in the form of DNNs representing deterministic control policies. Such a DNN maps system states (or raw sensor readings) to control inputs. RL is used in form of Deep Deterministic Policy Gradient (DDPG) algorithm, with the safe learning strategy of penalizing unrecoverable actions from [32]. DDPG was chosen because it works with deterministic policies and is compatible with continuous action spaces. An advantage of off-policy algorithms such as DDPG is that the problem of exploration can be treated independently from the learning algorithm. Off-policy learning is advantageous in the present setting because it enables the NC to be (re-)trained using actions taken by the BC rather than the NC or the learning algorithm. The benefits of off-policy retraining are further considered in Section 5.4.3.

There is considered a standard RL setup consisting of an agent interacting with an environment in discrete time. At each time step t, the agent receives a (microgrid) state xₜ as input, takes an action aₜ, and receives a scalar reward rₜ. The DDPG algorithm employs an actor-critic framework. The actor generates a control action and the critic evaluates its quality. In order to learn from prior knowledge, DDPG uses a replay buffer to store training samples of the form (xₜ, aₜ, rₜ, xₜ₊₁). At every training iteration, a set of samples is randomly chosen from the replay buffer. For further details regarding the implementation of the DDPG algorithm, please refer to Algorithm 1 in [23].

To learn an NC for DER voltage control, the following reward function was designed, guiding the actor network to learn the desired control objective.

$$r ( {x}_{t} , {a}_{t} ) = [ \begin{matrix}- 1000 & if FSC ( {x}_{t} , {a}_{t} ) \\ 100 & if {v}_{od} ∈ [ {v}_{ref} - ϵ , {v}_{ref} + ϵ ] \\ - w \cdot {( {v}_{od} - {v}_{ref} )}^{2} & otherwise\end{matrix} \qquad Eq . 17$$

where ω is a weight (ω=100 in the experiments), v_{od} is the d-component of the output voltage of the DER whose controller is being learned, v_{ref} is the reference or nominal voltage, and ϵ is the tolerance threshold. A high negative reward is assigned for triggering the FSC, and a high positive reward for reaching the tolerance region, i.e., v_{ref}±ϵ. The third clause rewards actions that lead to a state in which the DER voltage is close to its reference value.

### Adversarial Inputs

Controllers obtained via deep RL algorithms are vulnerable to adversarial inputs (AIs): those that lead to a state in which the NC produces an unrecoverable action, even though the NC behaves safely on very similar inputs. NSA provides a defense against these kinds of attacks. If the NC proposes a potentially unsafe action, the BC takes over in a timely manner, thereby guaranteeing the safety of the system. To demonstrate NSA's resilience to AIs, a gradient-based attack (Algorithm 4) from [31] is used to construct such inputs, and show that the DM switches control to the BC in time to ensure safety.

The gradient-based algorithm takes as input the critic network, actor network, adversarial attack constant c, parameters a, b of beta distribution β(a, b), and the number of times n noise is sampled. For a given (microgrid) state x, the critic network is used to ascertain its Q-value and the actor network determines its optimal action. Once the gradient of the critic network's loss function is computed using the Q-value and the action, the l₂-constrained norm of the gradient (grad_dir) is obtained. An initial (microgrid) state x₀, to be provided as input to the actor network, is then perturbed to obtain a potential adversarial state x_{adv}, determined by the sampled noise in the direction of the gradient: x_{adv}=x₀−c·β(a, b)·grad_dir.

The Q-value of x_{adv} and its (potentially adversarial) action x_{adv} are now computed. If this value is less than Q(x₀, a₀), then x_{adv} leads to a sub-optimal action. The gradient-based attack algorithm does not guarantee the successful generation of AIs every time it is executed. The success rate is inversely related to the quality of the training of the NC. In the experiments (see Section 5.5.5), the highest success rate for AI generation that was observed is 0.008%.

### 5.4.3 Adaptation Module

The Adaptation Module (AM) retrains the NC in an online manner when the NC produces an unrecoverable action that causes the DM to failover to the BC. With retraining, the NC is less likely to repeat the same or similar mistakes in the future, allowing it to remain in control of the system more often, thereby improving performance. There is used Reinforcement Learning with the reward function defined in Eq. 17 for online retraining.

As in initial training, the DDPG algorithm (with the same settings) is used for online retraining. When the NC outputs an unrecoverable action, the DM switches control to the BC, and the AM computes the (negative) reward for this action and adds it to a pool of training samples. As in [32], it was found that reusing the pool of training samples (DDPG's experience replay buffer) from initial training of the NC evolves the policy in a more stable fashion, as retraining samples gradually replace initial training samples in the pool. Another benefit of reusing the initial training pool is that retraining of the NC can start almost immediately, without having to wait for enough samples to be collected online.

There are two methods to retrain the NC:
1. Off-policy retraining: At every time step while the BC is active, the BC's action is used in the training sample. The reward for the BC's action is based on the observed next state of the system.
2. Shadow-mode retraining: At every time step while the BC is active, the AM takes a sample by running the NC in shadow mode to compute its proposed action, and then simulates the behavior of the system for one time step to compute a reward for it.

In the experiments, both methods produce comparable benefits. Off-policy retraining is therefore preferable because it does not require simulation (or a dynamic model of the system) and hence is less costly.

### 5.5 Implementation and Experiments

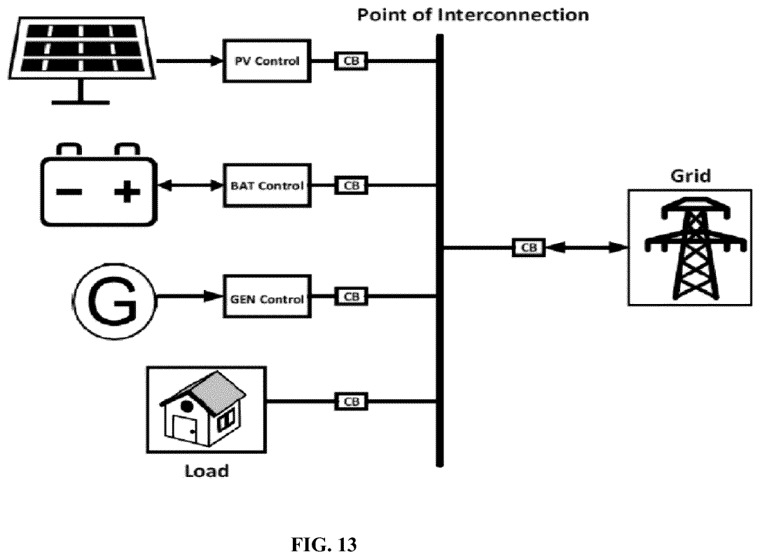

The proposed Bb-Simplex methodology is applied to a model of a microgrid [29] with three DERs: a battery, photovoltaic (PV, a.k.a. solar panels), and diesel generator. The three DERs are connected to the main grid via bus lines. As depicted in FIG. 13, the three DERs are connected to the main grid via bus lines. There is primarily interest in PV control, since Bb-Simplex is applied to PV voltage regulation. The PV control includes multiple components, such as “three-phase to DQ0 voltage and current” transformer, average voltage and current control, power and voltage measurements, inner-loop dq current control, and outer-loop Maximum Power Point Tracking (MPPT) control. The experimental evaluation of Bb-Simplex was carried out on RTDS, a high-fidelity power systems simulator.

Experiments were run for three configurations of the microgrid: Configuration 1: grid-connected mode with only the PV DER connected within the MG; Configuration 2: islanded mode with PV and diesel generator DERs connected within the MG; Configuration 3: islanded mode with PV, diesel generator, and battery (in discharging mode) DERs connected within the MG. All configurations also include a load. These configurations demonstrate Bb-Simplex's ability to handle a wide variety of MG configurations involving various types of DERs. Experiments were not performed with the battery in charging mode, because in this mode, the battery is simply another load, and the configuration is equivalent to Configuration 1 or Configuration 2 with a larger load.

The state of the MG plant is given by [i_{d}, i_{od}, i_{oq}, v_{od}, v_{oq}, i_{ld}, i_{lq}, m_{d}, m_{q}], where i_{d} and i_{q} are the d- and q-components of the dq current measured at the local load of the inverter, i_{od} and i_{oq} are the d- and q-components of the output current of the inverter measured at point of coupling to the main grid, v_{od} and v_{oq} are the d- and q-components of the output voltage of the inverter measured at point of coupling to the main grid, i_{ld} and i_{lq} are the d- and q-components of the input current to the current controller, m_{d} and m_{q} are the d- and q-components of the output voltage from the current controller used to generate the next state.

Bb-Simplex is used to ensure the safety property that the d-component of the output voltage (v_{od}) of the inverter for the PV DER is within ±3% of the reference voltage v_{ref}=0.48 kV. A 3% tolerance was adopted for the voltage, based on the discussion in [29]. Bb-Simplex could similarly be used to ensure additional desired safety properties. The BC is the droop controller described in [29]. All experiments use runs of length 10 seconds, with the control period, RTDS time step, and simulation time step in MATLAB all equal to 3.2 milliseconds (msec), the largest time step allowed by RTDS.

### 5.5.1 Integration of Bb-Simplex in RTDS

The BC is implemented in RTDS using components in the RTDS standard libraries. The DM is implemented as an RTDS custom component written in C. For an MG configuration, expressions for the BaC, λ and μ (see Section 5.3) are derived in MATLAB, converted to C data structures, and then included in a header file of the custom component. The BaCs are polynomials comprising 41, 67, and 92 monomials, respectively, for configurations 1, 2, and 3.

The NC is trained and implemented using Keras, a high-level neural network Python API developed by [15], running on top of TensorFlow from [8]. For training, there was customized an existing skeleton implementation of DDPG in Keras, which was then used with the Adam optimizer [19]. Hyperparameters used during training involved a learning rate lr=0.0001, discounting factor γ=0.99, and target network update weight τ=0.001.

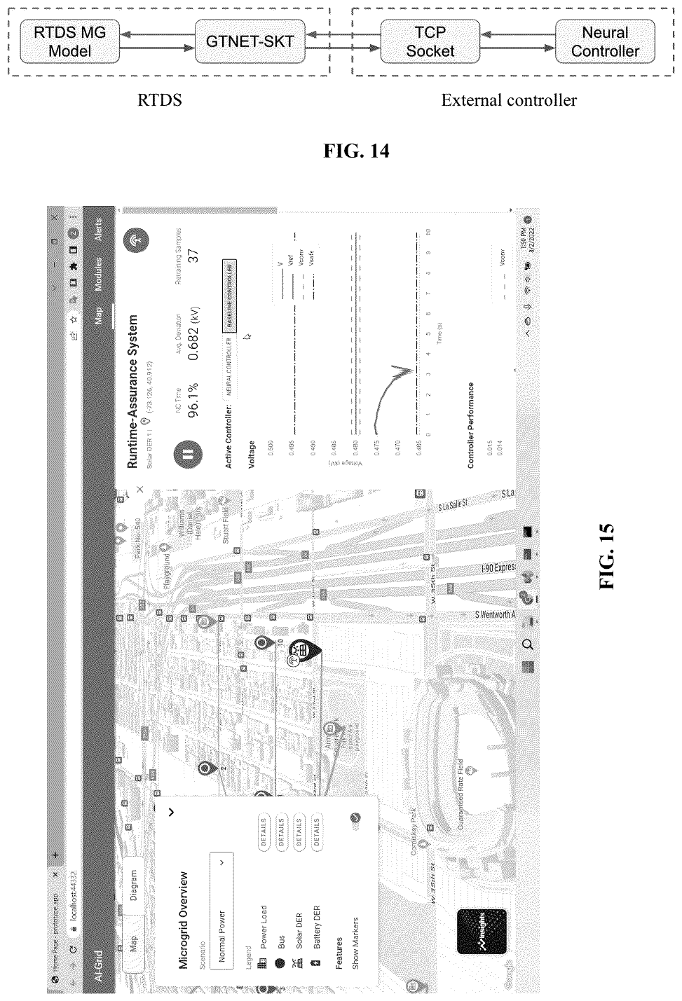

RTDS imposes limitations on custom components that make it difficult to implement complex NNs within RTDS. Existing NN libraries for RTDS, such as those developed by [25, 26], severely limit the NN's size and the types of activation functions. Therefore, the NC external to RTDS was implemented, following the software-defined microgrid control approach in [45]. FIG. 14 shows the setup. RTDS's GTNET-SKT communication protocol was used to establish a TCP connection between the NC running on a PC and an “NC-to-DM” relay component in the RTDS MG model. This relay component repeatedly sends the plant state to the NC, which computes its control action and sends it to the relay component, which in turn sends it to the DM.

Running the NC outside RTDS introduces control latency. The round-trip time between RTDS and NC (including the running time of NC on the given state) was measured to be 4.34 msec. Since the control period is 3.2 msec, each control action is delayed by one control period. The latency is mostly from network communication, since the PC running the NC was off-campus. There is a plan to reduce the latency by moving the NC to a PC connected to the same LAN as RTDS.

### 5.5.2 User Interface

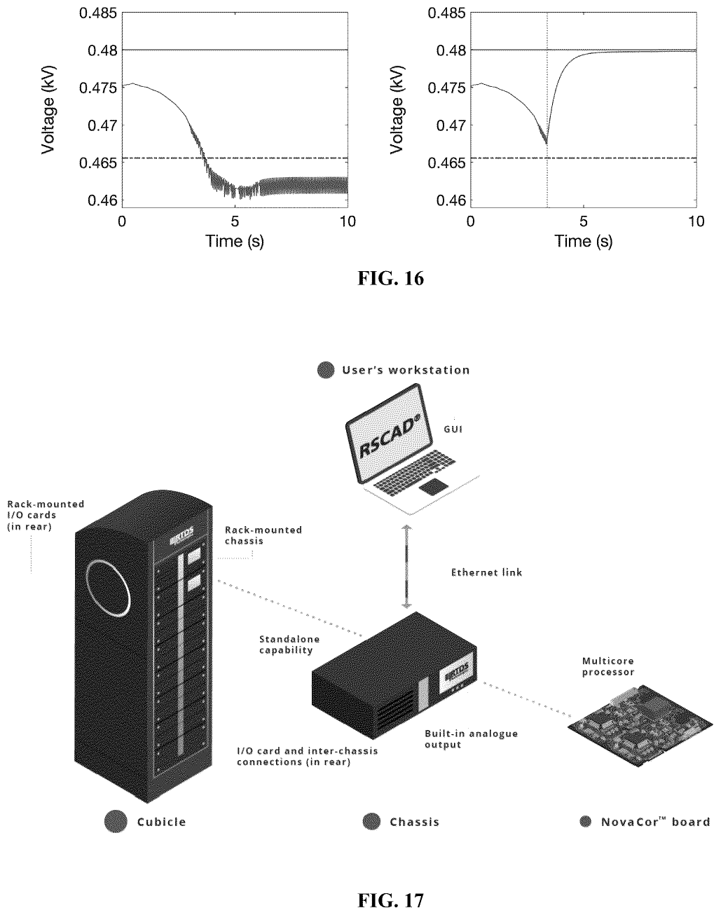

The AI-Grid user interface includes a panel that displays information related to Bb-Simplex. The screenshot in FIG. 15 shows the upper half of that panel for the PV DER, which is represented by the large black marker with the PV icon in the map-view panel; clicking on that marker opens the Bb-Simplex panel. The state of the system is shown partway through a simulated execution of the system starting from an adversarial input, described below in the paragraph on adversarial input attacks. The same execution is illustrated in the right part of FIG. 16.

The first line of data in the panel shows the percentage of time that the NC has been in control (NC Time), the average deviation of the voltage from the reference voltage (Avg Deviation), and the number of samples that have been used for online retraining of the NC (Retraining Samples). The next line shows which controller is currently active (i.e., in control), by highlighting its name. The graph below that shows the voltage as a function of time, with the red line indicating the reference voltage, and the black dashed/dotted lines delimiting the safety region.

Scrolling to the lower half of the panel (not shown in the figure) reveals three more graphs, which show the following quantities as functions of time: the deviation of the actual voltage from the reference voltage, the active controller, and the number of retraining samples.

### 5.5.3 Consistency of RTDS and MATLAB Models

The proposed methodology requires an analytical model of the microgrid dynamics to derive a BaC for the BC and a switching condition for the DM. Therefore, there was developed an analytical model in MATLAB based on the RTDS model and the description given in [29]. To verify consistency of MATLAB and RTDS models, comparisons were performed of trajectories obtained from them under various operating conditions.

Tables 6, 7, and 8 report deviations in output voltage and current trajectories of the PV DER between the two models under the control of the BC. The results are based on 100 trajectories starting from random initial states.

TABLE 6
Performance Comparison between output of
PV DER in RTDS and MATLAB models for Configuration 1

| | VD (kV) | VD (%) | CD (Amp) | CD (%) |
|---|---|---|---|---|
| Avg | 0.000214 | 0.04 | 0.000129 | 0.028 |
| Min | 0.000187 | 0.03 | 0.000124 | 0.015 |
| Max | 0.000378 | 0.08 | 0.000181 | 0.036 |

TABLE 7
Performance Comparison between output of
PV DER in RTDS and MATLAB models for Configuration 2

| | VD (kV) | VD (%) | CD (Amp) | CD (%) |
|---|---|---|---|---|
| Avg | 0.000348 | 0.07 | 0.000126 | 0.032 |
| Min | 0.000103 | 0.02 | 0.000104 | 0.019 |
| Max | 0.000493 | 0.10 | 0.000187 | 0.052 |

TABLE 8
Performance Comparison between output of
PV DER in RTDS and MATLAB models for Configuration 3

| | VD (kV) | VD (%) | CD (Amp) | CD (%) |
|---|---|---|---|---|
| Avg | 0.001041 | 0.12 | 0.000238 | 0.047 |
| Min | 0.000119 | 0.02 | 0.000133 | 0.019 |
| Max | 0.001403 | 0.21 | 0.000187 | 0.102 |

As expected, the two models are in close agreement. The small deviations are due to a few factors: (1) the RTDS model uses realistic dynamic models of transmission lines including their noise, whereas the MATLAB model ignores transmission line dynamics; and (2) the RTDS model uses average-value modeling to more efficiently simulate the dynamics in real-time [29], whereas in MATLAB, trajectories are calculated by solving ordinary differential equations of the dynamics at each simulation time-step.

### 5.5.4 Evaluation of Forward Switching Condition

A BaC was derived using the SOS-based methodology presented in Section 5.2, and then a switching condition was derived from the BaC, as described in Section 5.3.1. To find values of λ and μ, MATLAB's fmincon function was used to solve the constrained optimization problems given in Eqs. 2.10 and 2.11.

An ideal FSC triggers a switch to BC only if an unrecoverable state is reachable in one time step. For systems with complex dynamics, switching conditions derived in practice are conservative, i.e., may switch sooner. To show that the proposed FSC is not overly conservative, experiments were performed using an AC that continuously increases the voltage and hence soon violates safety. The PV voltage controller has two outputs, m_{d} and m_{q}, for the d and q components of the voltage, respectively. The dummy AC simply uses constant values for its outputs, with m_{d}=0.5 and m_{q}=1e−6.

These experiments were performed with PV DER in grid connected mode, with reference voltage and voltage safety threshold of 0.48 kV and 0.4944 kV, respectively, and a FSC derived using a 4th-order Taylor approximation of the BaC. There were averaged over 100 runs from initial states with initial voltage selected uniformly at random from the range 0.48 kV±1%. The mean voltage at switching is 0.4921 kV (with standard deviation 0.0002314 kV), which is only 0.46% below the safety threshold. The mean numbers of time steps before switching, and before a safety violation if Bb-Simplex is not used, are 127.4 and 130.2, respectively. Thus, the proposed FSC triggered a switch about three time steps, on average, before a safety violation would have occurred.

Moreover, a neural network-based BaC was also derived using deep learning and verified it using the Gurobi optimizer as discussed in Section 5.2. Then the switching conditions were derived from the verified neural BaC, again using a 4^{th}-order Taylor approximation. The same experiments as above were performed to determine the conservativeness of this FSC. The mean voltage at switching is 0.4923 kV (with standard deviation 0.0002132 kV). The mean numbers of time steps before switching, and before a safety violation if Bb-Simplex is not used, are 128.1 and 130.2, respectively. Thus, the neural FSC triggered a switch about two time steps, on average, before a safety violation would have occurred.

### 5.5.5 Evaluation of Neural Controller

The NC for a microgrid configuration is a DNN with four fully-connected hidden layers of 128 neurons each and one output layer. The hidden layers and output layer use the ReLU and tanh activation function, respectively. The input state to the NC (DNN) is the same as the inputs to the BC (droop controller) i.e., [i_{ld}, i_{lq}], where i_{ld} and i_{lq} are the d- and q-components of the input current to the droop controller. Thus, the NC has same inputs and outputs as the BC. The NC is trained on 1 million samples (one-step transitions) from MATLAB simulations, processed in batches of 200. Transitions start from random states, with initial values uniformly sampled from [0.646, 0.714] for i_{ld} and [−0.001, 0.001] for i_{lq} [29]. Training takes approximately 2 hours. The number of trainable parameters in the actor and critic networks are 198,672 and 149,111, respectively.

### Performance

A controller's performance is evaluated based on three metrics: convergence rate (CR), the percentage of trajectories in which the DER voltage converges to the tolerance region v_{vref}±ϵ; average convergence time (CT), the average time required for convergence of the DER voltage to the tolerance region; and mean deviation (δ), the average deviation of the DER voltage from v_{vref} after the voltage enters the tolerance region. Always reported were CR as a percentage, CT in milliseconds, and δ in kV.

TABLE 9
Performance comparison for Configuration 1

| Controller | CR | CT | σ(CT) | δ | σ(δ) |
|---|---|---|---|---|---|
| NC | 100 | 67.5 | 5.8 | 1.1e−4 | 1.0e−5 |
| BC | 100 | 102.3 | 8.2 | 4.2e−4 | 3.7e−5 |

TABLE 10
Performance comparison for Configuration 2

| Controller | CR | CT | σ(CT) | δ | σ(δ) |
|---|---|---|---|---|---|
| NC | 100 | 76.8 | 6.1 | 1.3e−4 | 1.2e−5 |
| BC | 100 | 108.8 | 8.3 | 5.le−4 | 3.8e−6 |

TABLE 11
Performance comparison for Configuration 3

| Controller | CR | CT | σ(CT) | δ | σ(δ) |
|---|---|---|---|---|---|
| NC | 100 | 81.1 | 7.7 | 1.5e−4 | 1.3e−5 |
| BC | 100 | 115.7 | 9.8 | 5.8e−4 | 3.8e−6 |

It was shown that the NC outperforms the BC. For this experiment, RTDS was used to run the BC and NC starting from the same 100 initial states. The CR is 100% for the NC and BC. Table 9, 10, and 11 compare their performance, averaged over 100 runs, with ϵ=0.001. It was observed that for all three configurations, the NC outperforms the BC both in terms of average convergence time and mean deviation. There were also reported the standard deviations (σ) for these metrics and it was noted that they are small compared to the average values. The FSC was not triggered even once during these runs, showing that the NC is well-trained.

### Generalization

Generalization refers to the NC's ability to perform well in contexts beyond the ones in which it was trained. First, there were considered two kinds of generalization with respect to the microgrid state:
Gen 1: the initial states of the DERs are randomly chosen from a range outside of the range used during training.
Gen 2: the power set-point P* is randomly chosen from the range [0.2, 1], whereas all training was done with P*=1.

TABLE 12
Generalization performance of NC for
Configuration 1

| | CR | CT | σ(CT) | δ | σ(δ) |
|---|---|---|---|---|---|
| Gen 1 | 100 | 108.7 | 9.8 | 1.7e−4 | 1.5e−5 |
| Gen 2 | 100 | 77.1 | 6.9 | 1.3e−4 | 1.1e−5 |

Tables 12, 13, and 14 present the NC's performance in these two cases, based on 100 runs for each case. It is seen that the NC performs well in both cases.

TABLE 13
Generalization performance of NC for
Configuration 2

| | CR | CT | σ(CT) | δ | σ(δ) |
|---|---|---|---|---|---|
| Gen 1 | 100 | 118.2 | 10.1 | 2.1e−4 | 1.9e−5 |
| Gen 2 | 100 | 81.2 | 6.2 | 1.5e−4 | 1.4e−5 |

TABLE 14
Generalization performance of NC for
Configuration 3

| | CR | CT | σ(CT) | δ | σ(δ) |
|---|---|---|---|---|---|
| Gen 1 | 100 | 120.4 | 10.8 | 2.2e−4 | 1.9e−5 |
| Gen 2 | 100 | 88.5 | 7.3 | 1.6e−4 | 1.4e−5 |

Second, generalization is considered with respect to the microgrid configuration. Here it is evaluated how the NC handles dynamic changes to the microgrid configuration during runtime. For the first experiment, all the 3 DERs are connected at the start, but the diesel generator DER is disconnected after the voltage has converged. For the second experiment, all the 3 DERs connected are connected at the start, but both the diesel generator and battery DER are disconnected after the voltage has converged. For both instances, the NC succeeded in continuously keeping the voltage in the tolerance region (v_{vref}±ϵ) after the disconnection. The disconnection caused a slight drop in the subsequent steady-state voltage, a drop of 0.114% and 0.132%, averaged over 100 runs for each case.

Finally, generalization was considered with respect to the microgrid configuration. Two sets of experiment were performed for this. Let NC-i denote the NC trained for Configuration i. In the first set of experiments, the performance of NC-1 was tested for Configuration 2 and NC-2 for Configuration 1 on 100 runs from random initial states. In both cases, the CR was 100%. However, the mean deviation for NC-1 was 4.7 times larger than when it was used with Configuration 1. The mean deviation for NC-2 was 2.4 times larger than when it was used with Configuration 2. It was concluded that an NC trained on a more complex microgrid generalizes better than one trained on a simpler microgrid.

In the second set of experiments, it was evaluated how NC-1 and NC-2 handle dynamic changes to the microgrid configuration, even though no changes occurred during training. Each run starts with the PV and diesel generator DERs both connected, and the diesel generator DER disconnected after the voltage has converged. Both NCs succeed in continuously keeping the voltage in the tolerance region (v_{vref}±ϵ) after the disconnection. The disconnection causes a slight drop in the subsequent steady-state voltage, a drop of 0.195% for NC-1 and 0.182% for NC-2.

### Adversarial Input Attacks

It was demonstrated that RL-based neural controllers are vulnerable to adversarial input attacks. There gradient-based attack algorithm described in Section 5.4.2 was used to generate adversarial inputs for the NCs. There were used an adversarial attack constant a=0.05 and the parameters for the beta distributions were a=2 and b=4. From 100,000 unique initial states, there were obtained 8, 6, and 5 adversarial states for Configurations 1, 2, and 3, respectively. In these experiments, all state variables were perturbed simultaneously. In a real-life attack scenario, an attacker might have the capability to modify only a subset of them. Nevertheless, the experiments illustrate the fragility of RL-based neural controllers and the benefits of protecting them with NSA.

It was confirmed with simulations that all generated adversarial states lead to safety violations when the NC alone is used, and that safety is maintained when Bb-Simplex is used. FIG. 16 (left) shows one such case, where the NC commits a voltage safety violation. The red horizontal line shows the reference voltage v_{vref}=0.48 kV. The black dashed horizontal line shows the lower boundary of the safety region, 3% below v_{vref}. FIG. 16 (right) shows how Bb-Simplex prevents the safety violation. The pink dotted vertical line marks the switch from NC to BC.

It was also confirmed that for all generated adversarial states, the forward switch is followed by a reverse switch. The time between forward switch and reverse switch depends on the choice of m (see Section 5.3.2). In the run shown in FIG. 16 (right), they are 5 time steps (0.016 sec) apart; the time of the reverse switch is not depicted explicitly, because the line for it would mostly overlap the line marking the forward switch. For m=2, 3, 4 with Configuration 1, the average number of time steps between them are 7 (0.0244 sec), 11 (0.0352 sec), and 16 (0.0512 sec), respectively. For m=2, 3, 4 with Configuration 2, the average time steps between them are 7 (0.0244 sec), 13 (0.0416 sec), and 17 (0.0544 sec), respectively. For m=2, 3, 4 with Configuration 3, the average time steps between them are 8 (0.0256 sec), 14 (0.0448 sec), and 19 (0.0608 sec), respectively.

### 5.5.6 Evaluation of Adaptation Module

To measure the benefits of online retraining, the adversarial inputs described above were used to trigger switches to BC. The switching conditions derived using the SOS-based methodology were used. For each microgrid configurations, the original NC was ran from the first adversarial state for that configuration, online retraining was performed while the BC is in control, and this procedure was repeated for the remaining adversarial states for that configuration except starting with the updated NC from the previous step. As such, the retraining is cumulative for each configuration. This entire procedure was performed separately for different RSCs corresponding to different values of m. After the cumulative retraining, the retrained controller was run from all of the adversarial states, to check whether the retrained NC was still vulnerable (i.e., whether those states caused violations).

For Configuration 1, the BC was in control for a total of 56, 88, and 128 time steps for m=2, 3, 4, respectively. For Configuration 2, the BC was in control for a total of 42, 78, and 102 time steps for m=2, 3, 4, respectively. For Configuration 3, the BC was in control for a total of 40, 70, and 95 time steps for m=2, 3, 4, respectively. For m=2, the retrained controllers were still vulnerable to some adversarial states for each configuration. For m=3,4, the retrained controllers were not vulnerable to any of the adversarial states, and voltage always converged to the tolerance region. Performance comparison of the original and retrained NCs, averaged over 100 runs starting from random (non-adversarial) states shows a slight improvement in the performance of the retrained NC (13.4% for CT and 6% for δ). Thus, retraining improves both safety and performance.

Tables 15, 16, and 17 compare the performance of the original and retrained NCs for each configuration, averaged over 100 runs starting from random (non-adversarial) states. The re-training shows a slight improvement in the performance of the NC; thus, retraining improves both safety and performance.

TABLE 15
Performance comparison of original NC and
NC retrained by AM for Configuration 1

| NC | CR | CT | σ(CT) | δ | σ(δ) |
|---|---|---|---|---|---|
| retrained | 100 | 60.4 | 5.6 | 1.0e−4 | 1.0e−5 |
| original | 100 | 67.5 | 5.8 | 1.1e−4 | 1.0e−5 |

TABLE 16
Performance comparison of original NC and
NC retrained by AM for Configuration 2

| NC | CR | CT | σ(CT) | δ | σ(δ) |
|---|---|---|---|---|---|
| retrained | 100 | 69.4 | 5.3 | 1.1e−4 | 1.0e−5 |
| original | 100 | 76.8 | 6.1 | 1.3e−4 | 1.2e−5 |

TABLE 17
Performance comparison of original NC and
NC retrained by AM for Configuration 3

| NC | CR | CT | σ(CT) | δ | σ(δ) |
|---|---|---|---|---|---|
| retrained | 100 | 70.2 | 5.7 | 1.4e−4 | 1.3e−5 |
| original | 100 | 81.1 | 7.7 | 1.5e−4 | 1.3e−5 |

A potential concern is whether with online retraining can be done in real-time; i.e., whether a new retraining sample can be processed within one control period, so the retrained NC is available as soon as the RSC holds. In the above experiments, run on a laptop with an Intel i5-6287U CPU, retraining is done nearly in real-time: on average, the retraining finishes 0.285 milliseconds (less than one-tenth of a control period) after the RSC holds.

### 5.6 Extension to Approximate Dynamics

In this section, there proposed Bb-Simplex framework was extended to handle approximate knowledge of the system dynamics, due to approximate knowledge of the dynamic equations or of the values of parameters in the dynamic equations. It is noted that there is continued assumption that the dynamics is deterministic; the proposed framework can be further extended to handle uncertainty due to non-deterministic dynamics. Approximate dynamics may be obtained, for example, by learning it from execution traces. The concepts of BaC and switching condition are extended to take into account the inaccuracy in the dynamics, using a given bound on the approximation error. The bound may be learned together with the approximate dynamics or determined later while checking conformance between the approximate dynamics and the observed behavior.

Continue to let f denote the (unknown) actual dynamics, as in Eq. 5. Let f* denote the approximate dynamics.

Definition 2 (Approximation error ϵ): The approximation error e is a bound on the difference between the actual dynamics and the approximate dynamics over the domains of the system state and the control action.

$$ϵ \geq sup \{ \vert f ( x , u ) - {f}^{*} ( x , u ) \vert , x ∈ 𝒜 , u ∈ 𝒰 \} \qquad Eq . 18$$

First consider the impact of the approximation error on the definition of the BaC and the SyntheBC algorithm [50] for deriving a neural BaC. Then consider its impact on proposed methodology for deriving switching conditions.

### 5.6.1 Impact of Approximate Dynamics on BaC

Suppose a BaC h* is derived using the approximate dynamics f*. Thus, the conditions in Eq. 6 hold with h replaced with h*, and f replaced with f*. However, h* is not necessarily a BaC for the actual dynamics f, since it may not satisfy the derivative condition, namely,

$$f ( x ) \frac{\partial {h}^{*}}{\partial x} f \geq 0 , ∀ x : {h}^{*} ( x ) = 0 .$$

To address this issue, a modified (stronger) version of the derivative condition is used when learning a BaC from the approximate dynamics. The modified condition ensures that the resulting BaC h* is also a BaC for the actual dynamics. The modified derivative condition is:

$$y \frac{\partial {h}^{*} ( x )}{\partial x} \geq 0 , ∀ x : {h}^{*} ( x ) = 0 , ∀ y ∈ [ {f}^{*} ( x ) - ϵ , {f}^{*} ( x ) + ϵ ] \qquad Eq . 19$$

Theorem 3: If a function h*: [symbol] ^{d}→ [symbol] satisfies the definition of a BaC given in Eq. 6, except with the derivative condition (the last condition) replaced with Eq. 19, for an approximate dynamics f* with error bound ϵ, then h* is a BaC for the actual dynamics f.

Proof. The dynamics f does not occur in the first two conditions of Eq. 6, so h* satisfies them for both dynamics. It remains to show that h* also satisfies the final condition, the derivative condition, for the actual dynamics. This holds because the condition in Eq. 19 ensures that the derivative of h* is non-increasing for all possible values that f(x) can assume, specifically, for all values within ϵ of f*(x).

### Learning a Neural BaC From Approximate Dynamics

The SyntheBC algorithm [50] is modified for learning a candidate BaC in the form of an NN, and verifying the candidate BaC, so that it uses a proposed modified version of the derivative condition.

The training that seeks to ensure that the NN satisfy the first two conditions in the definition of a BaC, and the verification that the candidate BaC satisfies these two conditions, remain unchanged. The training that aims to make the NN satisfy the derivative condition needs to be modified, to take into account the changes to that condition. In particular, the loss function l₃ used in that training is modified so that it takes into account all of the values that the actual dynamics f could have, consistent with the approximate dynamics f*. The original definition of l₃ ensures that there is a loss (i.e., l₃ is positive) if the Lie derivative of N, given by the dot product

$$\frac{\partial N}{\partial x} f ( x ) ,$$

is positive for any point x in a dataset D₃ created earlier during training, where the NN N is the current candidate BaC.

The l₃ is modified so that there is a loss if the Lie derivative of N is positive anywhere in the box of size e around f*(x). Thus, l₃ is now based on the maximum value of that Lie derivative in that box. Since, for a given value of x, the dot product

$$\frac{\partial N}{\partial x} {f}^{*} ( x )$$

is a multi-linear function of the components of the vector f*(x), that maximum can be computed efficiently by exploiting the fact that it must occur at one of the corners of the box.

Verification of neural BaC: To verify that a candidate BaC satisfies the modified derivative condition, the MIQCP optimization problem in [51] is modified by considering an extra constraint on the values of the dynamics. The original MIQCP optimization problem checks that the maximum value of the dot product vf(x) is non-positive, subject to a set of constraints on v and x. The problem is modified to check whether the maximum value of the dot product vy is non-positive, where y is a fresh variable and the set of constraints is extended with the constraints y≥f*(x)−ϵ and y≤f*(x)+ϵ.

### 5.6.2 Impact of Approximate Dynamics on FSC

Recall from Theorem 2 that the FSC derived by the proposed methodology is of the form FSC(x, u)=α∨β, where α≡ĥ(x, u)−λ(u)≤0 and [symbol] ᵣβ≡x∉(u). The impact on each disjunct is considered.

### Impact on α

Recall that ĥ(x, u), defined in Eq. 7 is a Taylor approximation of BaC h's value after time η, if control action u is taken in state x, and ĥ(x, u)−λ(u) is a lower bound on h's value after time η. The impact of approximate dynamics on the BaC was already discussed. Now its impact is analyzed on the Taylor approximation of the BaC. For concreteness, consider the Taylor approximation of degree 2, and expand the derivatives in Eq. 7 using the chain rule:

$$\hat{h} ( x , u ) = h ( x , u ) + \frac{\partial h}{\partial x} f ( x , u ) η + \frac{1}{2} ( {f}^{T} ( x , u ) \frac{{\partial }^{2} h}{\partial {x}^{2}} f ( x , u ) + \frac{\partial h}{\partial x} \frac{\partial f}{\partial x} {f}^{*} ( x , u ) ) {η}^{2} \qquad Eq . 20$$

The approximation error ϵ by itself does not imply a bound on the difference between the derivatives of f and the derivatives of f*. For example, if f* oscillates within a small range, and f maintains a steady value within that range, then their derivatives may differ significantly, making ĥ*(x, u) a poor estimate of ĥ(x, u). To deal with this problem, there are introduced bounds on the approximation error in the derivatives of f; these can be obtained in a similar way as the approximation error in f.

Definition 3 (Derivative approximation error ϵᵢ): The derivative approximation error ϵᵢ is a bound on the maximum difference between the i^{th} derivatives of the actual dynamics and the approximate dynamics with respect to state x over the domains of the system state and the control action.

$${ϵ}_{i} = sup \{ \vert \frac{{\partial }^{i} f ( x , u )}{\partial {x}^{i}} - \frac{{\partial }^{i} {f}^{*} ( x , u )}{\partial {x}^{i}} \vert , x ∈ 𝒜 , u ∈ 𝕌 \} \qquad Eq . 21$$

Using these bounds, define ĥ*(x, u, ϵ, ϵ₁) in a way that ensures it is a lower bound on ĥ*(x, u).

$${\hat{h}}^{*} ( x , u , ϵ , {ϵ}_{1} ) = inf \{ {h}^{*} ( x ) + \frac{\partial {h}^{*}}{\partial x} ( {f}^{*} ( x ) + δ ) η + \frac{1}{2} ( ( {f}^{* T} ( x ) + {δ}^{T} ) \frac{{\partial }^{2} {h}^{*}}{\partial {x}^{2}} ( {f}^{*} ( x ) + δ ) + \frac{\partial {h}^{*}}{\partial x} ( \frac{\partial {f}^{*}}{\partial x} + {δ}_{1} ) ( {f}^{*} ( x ) + δ ) ) {η}^{2} : δ ∈ [ - ϵ , ϵ ] , {δ}_{1} ∈ [ - {ϵ}_{1} , {ϵ}_{1} ] \} \qquad Eq . 22$$

There is defined a remainder error λ*(u, ϵ, ϵ₂) that is an upper bound on the remainder error λ(u) by modifying the definition in Eq. 9 in a similar way.

This analysis can be generalized to higher-degree Taylor approximations. When using approximate dynamics with a degree-n Taylor approximation, α is defined by ĥ*(x, u, ϵ, ϵ₁, . . . , ϵₙ₋₁)−λ*(u, ϵ, ϵₙ)≤0.

### Impact on β

Recall that the β disjunct of the FSC derived using the actual dynamics checks whether the state is in a shrunken admissible region [symbol] ᵣ. When using approximate dynamics, modify the definition of the shrunken admissible region to further shrink it by an amount proportional to the error bound ϵ. This ensures that the analog of Lemma 2.1 holds; i.e., if β is true in the current state, then the system remains within the actual admissible region during the next control period.

The modified restricted admissible region is denoted [symbol] ᵣ*(u, ϵ) and is given by:

$${𝒜}_{r}^{*} ( u , ϵ ) = \{ x : {x}_{lb} + {μ}_{dec}^{*} ( u , ϵ ) < x < {x}_{ub} - {μ}_{inc}^{*} ( u , ϵ ) \} \qquad Eq . 23$$

where vectors u*_{dec}(u, ϵ), u*_{inc}(u, ϵ) are defined by:

$${μ}_{dec}^{*} ( u , ϵ ) = η ( \vert min ( 0 , {\dot{x}}_{min}^{*} ( u ) ) \vert + ϵ ) \qquad Eq . 24$$

$${μ}_{inc}^{*} ( u , ϵ ) = η ( \vert max ( 0 , {\dot{x}}_{min}^{*} ( u ) ) \vert + ϵ )$$

where \dot{x}*ₘᵢₙ and \dot{x}*ₘₐₓ are vectors of solutions to the optimization problems:

Lemma 2: For all x∈ [symbol] ᵣ(u, ϵ) and all control actions u, Reach_{≤η}(x, u)⊆ [symbol] .

$${\dot{x}}_{min}^{*} ( u ) = inf \{ {f}^{*} ( x , u ) : x ∈ 𝒜 \} \qquad Eq . 25$$

$${\dot{x}}_{max}^{*} ( u ) = sup \{ {f}^{*} ( x , u ) : x ∈ 𝒜 \}$$

The proof is similar to the proof of Lemma 1.

When using approximate dynamics, β is defined by β≡x∉ [symbol] *ᵣ(u, ϵ).

### 5.7 Extension to Hybrid Systems

In this section, there is a brief discussion on how to extend the proposed Bb-Simplex framework to hybrid systems. A hybrid system is a system with both discrete and continuous variables and with multiple modes, each with a different dynamics (for the continuous variables). Given a continuous state space [symbol] and finite set of modes M, the overall state space of the hybrid system is denoted by (m, x)∈M× [symbol] . Discrete mode-transitions occur instantaneously in time. A transition ((m, x), (m′, x′)) indicates that the system can undergo a discrete (instantaneous) transition from the state (m, x) to the state (m′, x′). Guards (G) and Reset maps (R) are defined for mode-transitions as follows:
G(m, m′)={x∈ [symbol] :((m, x), (m′, x′))∈ [symbol] for some x′∈ [symbol] }
and R(m, m′):x [symbol] {x′∈ [symbol] :(m, x), (m′, x′))∈ [symbol] }, whose domain is G(m, m′).

### 5.7.1 Switching Logic for Hybrid Systems

Consider the plant dynamics:

$$\dot{x} = f ( m , x , u ) \qquad Eq . 26$$

The set of unsafe states in mode m is denoted by [symbol] ₘ. For a given BC, denote the recoverable region for mode m by [symbol] ₘ. BaCs are functions that capture the following safety requirements of a hybrid system: (1) the state must remain safe during the continuous time evolution of the system in the current mode, and (2) a discrete transition ((m, x)(m′, x′)) from mode m to m′ must reset a safe state (m, x)∉ [symbol] ₘ to another safe state (m′, x′)∉ [symbol] _{m′}. Given a hybrid system Π, the safety of Π can be verified using a collection of BaCs hₘ: [symbol] ^{d}→ [symbol] , ∀m∈M(x), where M(x) is the set of modes consistent with current state x; i.e., the state x is invariant in the set of modes M(x).

$$\begin{matrix}{h}_{m} ( x ) < 0 , & ∀ x ∈ {𝒰}_{m} \\ {h}_{m} ( x ) \geq 0 , & ∀ x ∈ {ℝ}^{d} \backslash {𝒰}_{m} \\ \begin{matrix}{( {∇}_{x} {h}_{m} )}^{T} f ( m , x , u ) + \\ σ ( {h}_{m} ( x ) ) \geq 0\end{matrix} , & ∀ x ∈ {ℝ}^{d} \\ {h}_{m′} ( x′ ) \geq 0 , & ∀ ( ( m , x ) , ( m′ , x′ ) ) ∈ 𝒯 , {h}_{m} ( x ) \geq 0 , x ∈ G ( m , m′ ) , x′ ∈ R ( m , m′ ) ( x )\end{matrix} \qquad Eq . 27$$

The first three clauses are similar to the BaC defined in Eq. 6. The last clause guarantees hm cannot become negative after Π performs a discrete transition. If all the clauses in Eq. 27 are satisfied for all modes m∈M(x), hₘ is a barrier certificate of Π, where the safety of Π is certified. For a further exploration of Eq. 27, refer to [46].

In hybrid systems, mode switches can occur at any point in continuous time, not limited to multiples of a fixed time period. Thus, it is to be ensured that the computed set of reachable states is always safe and recoverable even if a mode transition happens within time η. The reachset computations should take into account all the states reachable from the current state within time η, for all of the modes consistent with the current state. The Reach_{≤η}(x, u) is computed using the methodology described in Section 3.5.2 of [9]. Their approach is directly applicable to the proposed approach, where their time interval [0, r], state x(0), mode y(0) and control action u(0) are analogous to the control period η, state x, mode m∈M(x) and control action u, respectively.

### 5.7.2 FSC for Hybrid Systems

To define the forward switching condition for hybrid systems, extend Definition 1 is extended. Let M(x, u, η) be the set of all modes reachable from state x in time interval η using control action u. It should be noted that M(x, u, η)⊆M.

Definition 4 (Forward Switching Condition): A condition FSC(x, u) is a forward switching condition for hybrid systems if for every recoverable state x, control action u, control period η, and modes m∈M(x, u, η), Reach_{≤η}(x, u)∩ [symbol] ≠∅∨Reach_{=η}(x, u) [symbol] ∩_{m∈M(x,u,η)} [symbol] ₘ implies FSC(x, u) is true.

Theorem 4: A Simplex architecture whose forward switching condition satisfies Definition 4 keeps the hybrid system invariably safe provided the system starts in a recoverable state.

Extending Theorem 2, there is now proposed a new procedure for constructing a switching condition for hybrid systems from a BaC and prove its correctness. The existing definitions are extended from Section 5.3 to hybrid systems by replacing h with hₘ to obtain ĥₘ(x, u) and λₘ(u). Similarly, the sets of admissible states and restricted admissible states for mode m are [symbol] ₘ and [symbol] ₘ^{r}, respectively.

Theorem 5: Given a barrier certificate hm, the following condition is a forward switching condition: FSC(x, u)=α∨β where,

$$α ≡ {∧}_{m ∈ M ( x )} \{ {\hat{h}}_{m} ( x , u ) - {λ}_{m} ( u ) \leq 0 \} and β ≡ x ∉ {⋂}_{m ∈ M ( x )} {𝒜}_{m}^{r} ( u ) .$$

### 5.8 Related Work

The use of BaCs in the Simplex architecture originated in [46]. There are, however, significant differences between their method for obtaining the switching condition and the proposed method. Their switching logic involves computing, at each decision period, the set of states reachable from the current state within one control period, and then checking whether that set of states is a subset of the zero-level set of the BaC. The proposed approach avoids the need for reachability calculations by using a Taylor approximation of the BaC, and bounds on the BaC's derivatives, to bound the possible values of the BaC during the next control period and thereby determine recoverability of states reachable during that time. The proposed approach is computationally much cheaper: a reachability computation is expensive compared to evaluating a polynomial. Their framework can handle hybrid systems. Extending the proposed method to hybrid systems is a direction for future work.

Mehmood et al. [27] propose a distributed Simplex architecture with BCs synthesized using control barrier functions (CBFs) and with switching conditions derived from the CBFs, which are BaCs satisfying additional constraints. A derivation of switching conditions based on Taylor approximation of CBFs is briefly described but does not consider the remainder error, admissible states, or restricted admissible states, and does not include a proof of correctness (which requires an analysis of the remainder error).

Kundu et al. [21] and Wang et al. [44] use BaCs for safety of microgrids, and Prajna et al. [37] propose an approach for stochastic safety verification of continuous and hybrid systems using BaCs. These approaches are based on the use of verified-safe controllers; they do not allow the use of unverified high-performance controllers, do not consider switching conditions, etc.

The application of neural networks for microgrid control is gaining in popularity [24]. Amoateng et al. [10] use adaptive neural networks and cooperative control theory to develop microgrid controllers for inverter-based DERs. Using Lyapunov analysis, they prove that their error-function values and weight-estimation errors are uniformly ultimately bounded. Tan et al. [43] use Recurrent Probabilistic Wavelet Fuzzy Neural Networks (RPWFNNs) for microgrid control, since they work well under uncertainty and generalize well. More traditional DNNs, since they are already high performing, and the focus is on safety assurance. The proposed Bb-Simplex framework, however, allows any kind of neural network to be used as the AC and can provide the safety guarantees lacking in their work. Unlike the proposed approach, none of these works provides safety guarantees.

### 6. SOFTWARE PLATFORM FOR AI-GRID

The AI-Grid project has multiple functionalities, including SDC (Software Defined Control), Power flow, Reachability analysis, neuron network based data prediction, etc. The CEWIT team is responsible for putting all these different components together and making a software platform for the AI-Grid project. When in the design and development stage, there was realization that all the functionality works on the Bronzeville Community Microgrid, but each team focuses on different aspects, and has different data requirements. In order to put things together while keeping each component apart from affecting each other, the software team in CEWIT created a generic architecture, which includes both backend data flow and a frontend UI. Then this generic architecture is customized for each team for different input, algorithms, and output. Different dnp3 outstation, SQL server database, dnp3 master, a panel in the front end is developed for different components.

Hereinbelow, there is first discussion of the infrastructure hardware of the system. Second, there is discussion about the overall generic architecture, and then discussion of the role for each component. And finally there is discussion of the customization for each project. Since this platform is still being developed, there is only discussion about the SDC, power flow and simplex project, being more mature right now.

### 6.1 Infrastructure Overview

### 6.1.1 Real Time Digital Simulator (RTDS)

The RTDS, shown in FIG. 17 (Real Time Digital Simulator) is a special purpose multi-processor computer system that is optimized for power system simulations. It is designed for real-time simulation, which means that the computation of the simulated system advances one moment in each moment of wall-clock time.

In the proposed system, the RTDS was used to run the BCM (Bronzeville Community Microgrid) model. The signal can be received from the RTDS system, a proposed control signal can be computed, and the computed signal can then be sent back to RTDS.

There are currently 2 systems of RTDS in the power lab, one in Suffolk Hall in Stony Brook campus and one in CEWIT. However, because the BCM model requires 4 cores in 2 racks to run, there is currently only use of the Suffolk Hall RTDS to run the simulation.

### 6.1.2 Windows

In order to run the proposed SDC control system, one machine was needed to host the programs to communicate with RTDS, another program to save the data, and another to run the SDC control program. MS windows 11 is useful to work with in connection with the proposed work and improvements.

### 6.1.3 Network

The windows machine resides in Suffolk Hall, sits right next to the RTDS. This machine is also directly connected to RTDS using network cable for a fast communication speed. This machine has an IP of 172.20.28.169, which is also in the architecture FIG. 17. All machines in the Suffolk hall site are in a local powerlab network, which is accessible from outside by VPN only.

### 6.1.4 SQL Server

Microsoft SQL Server is a relational database management system developed by Microsoft. As a database server, it is a software product with the primary function of storing and retrieving data as requested by other software applications—which may run either on the same computer or on another computer across a network. [2]

In the proposed project, there were used MS SQL Server 2022 (16.0) Community version as the data storage because of its free and easy to use feature.

SQL Server Management Studio 18.0 was also installed to access and manipulate the database.

### 6.1.5 Python

Python 3.11 was used in all the AI Grid algorithms, functions, and data manipulation. Multiple python libraries would be used in the project, like numpy, pytorch, pyodbc, etc. [5]

### 6.1.6 DNP3

DNP3 (aka IEEE 1815) is the most common SCADA protocol used in electric power in North America. It is event-based and efficiently transfers measurement data between outstation and master components [3].

Since use of DNP3 is required to communicate with RTDS and real SCADA device in the future, there is used C version open source DNP3 library [4] from Stepfunc in this project.

### 6.1.7 Asp.net Web Server

In this project, the asp.net website is used to visualize the result. Note this component may not be necessary in some projects. For example, in the SDC project, since the SDC is mainly a backend control process, it is not needed to visualize the control signal.

### 6.2 Software Architecture Overview

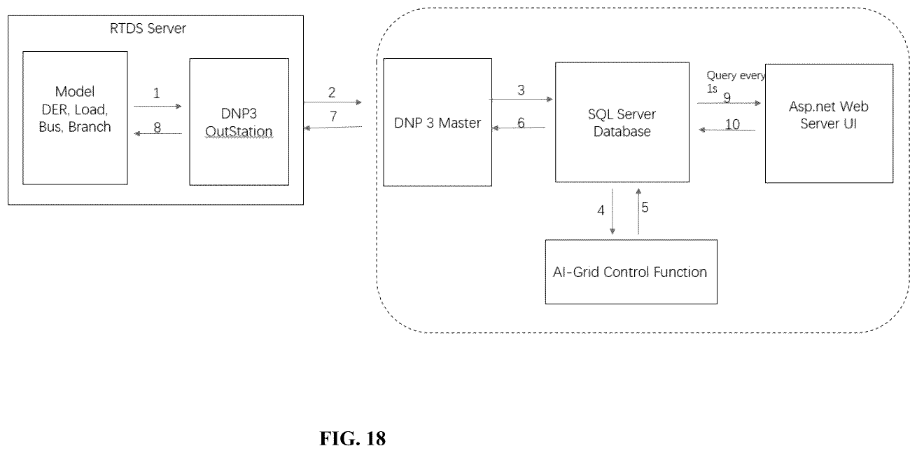

The overall AI-Grid software architecture is shown in FIG. 18. The overall workflow is as follows, which action is described in steps, note each bullet step number corresponds to the same number in the figure.

(1) Send data out using DNP3 outstation in RTDS; (2) Receive data using DNP3 master; (3) Save data into Database; (4) Run AI-Grid code to get updated value; (5) Save computed value back to database (6) C program read value from database; (7) Send control value back to RTDS using DNP3 master; (8) Receive value in RTDS using Outstation; (9) Update front end with database value; and (10) Save updated values from user input.

### 6.3 Software Architecture Component

### 6.3.1 RTDS

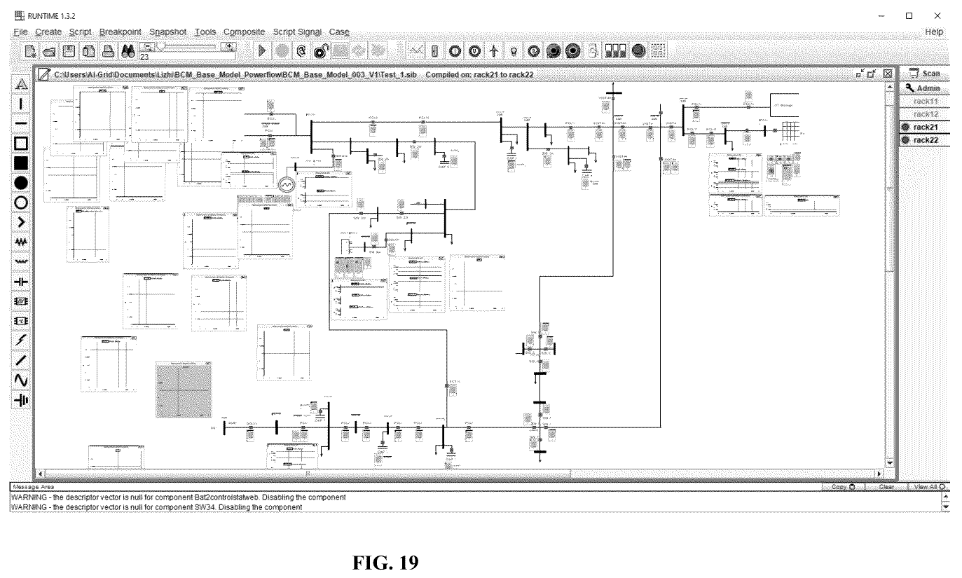

In the BCM model received from ComEd, the runtime view of the microgrid as shown in FIG. 19, there can be seen the connection topology, turn switch on/off, display system status, like voltage, active power and reactive power in this dashboard.

And in order to compute different AI-Grid functions, different multiple inputs are needed from the BCM model, e.g., active power, reactive power, voltage, etc. from the DER, Bus, Load, Branch. Note in this microgrid, there are 3 DERS: 1 Solar PV, 1 diesel generator, 1 battery. The original microgrid has 90+ loads, but in proposed project, 15 most important loads were selected for easier demonstration.

### 6.3.2 DNP3

A local version of C master and outstation were first configured to test the speed of the communication. It would take 15 ms to send one float value in a round trip, averaged from 1000 test times. There was also tested C++ version, which would take only 3 ms. However, since C++ is hard to integrate with other components, C was employed for easier usage.

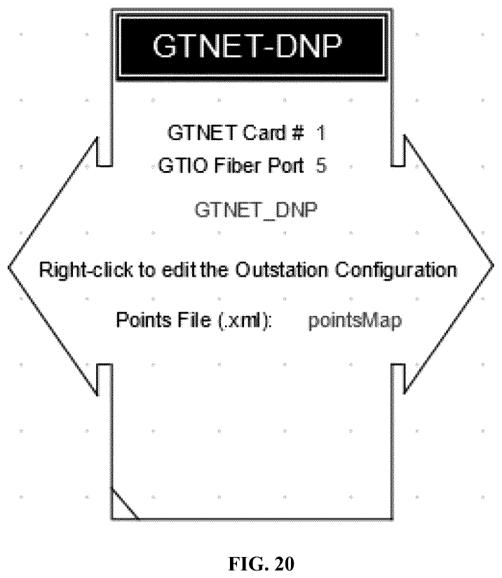

GTNet-DNP model from RTDS shown in FIG. 20 is used to send the data out. In this model, the outstation can be configured to specify what data to be sent. From outside, there is needed to configure a master file to receive the data. A speed test is also run to test the communication delay, the result is around 25 ms including the database write and read for a single float value, averaged from 1000 test times.

### 6.3.3 Special Encoding/Decoding Process

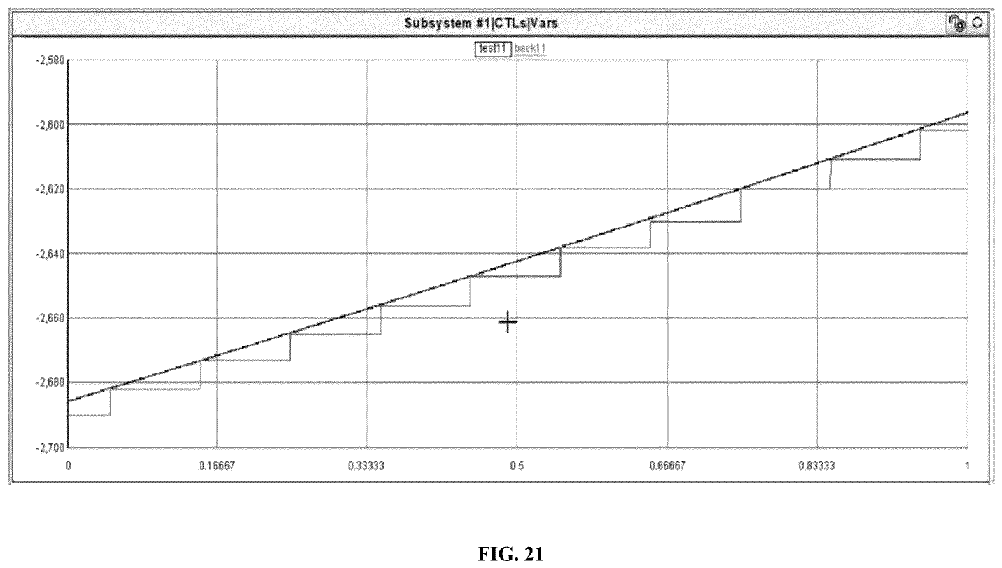

During the testing, it was realized that the analog values can be sent and received roundtrip only at a 100 ms interval, which is a limit set by RTDS. FIG. 21 shows this, the y-axis is the value, x-axis is the time, unit in second. Black line is the signal generated from RTDS, red line is the data received by RTDS after it is sent out and then sent back and received. The DNP3 is configured to sample every 1 ms, so DNP3 itself is not the bottleneck. In this figure, there can be seen 10 steps in 1 second, which means the delay is 0.1 s or 100 ms. This speed is ok for some projects, like power flow, but not fast enough for SDC controllers, which is preferred to be at 10 ms level. In RTDS, the binary value can be sent every 50 us. So in order to accomplish this 10 ms control speed, a binary encoder/decoder was implemented.

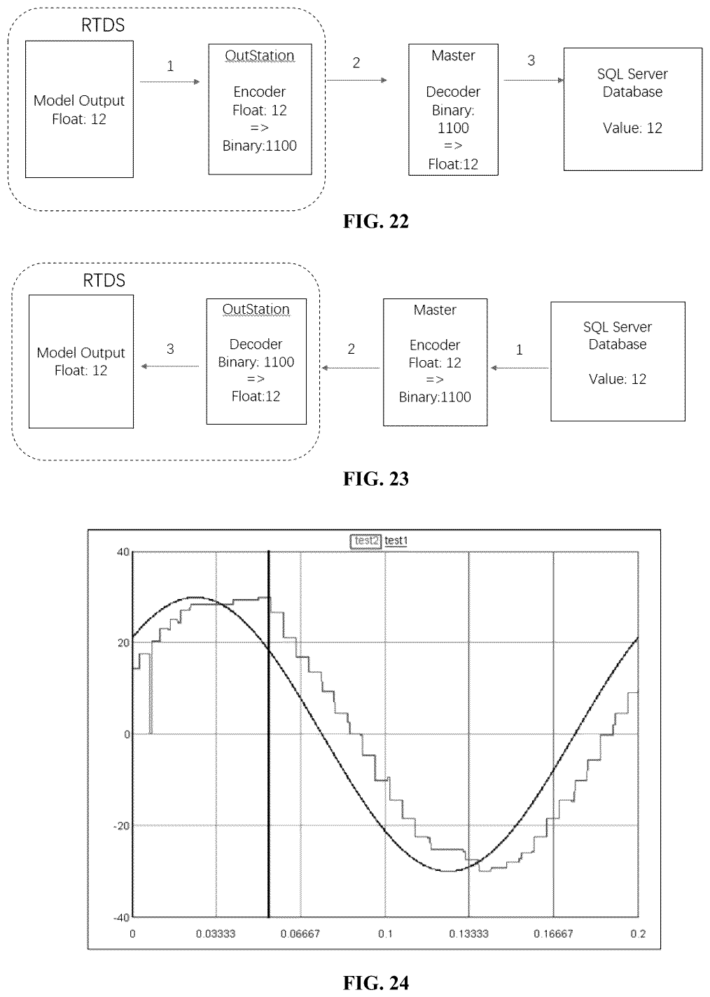

The data encoding/decoding from RTDS to database is illustrated in FIG. 22, with following steps: (1) Get values from RTDS; (2) Encode data into binary in RTDS outstation; (3) Send Data using DNP3; (4) Decode data in Master file; (5) Save to database. Here, an example is if one wants to send a value 12, it will be encoded into 1100 (12=23+22+21+20), and sent to the master file, decoded as 12 and saved into the database. It should be noted that in actual proposed SDC implementation, 16 bits were actually used to represent the value and 1 extra bit for the positive/negative sign.

The data encoding/decoding from database or controller to RTDS is illustrated in FIG. 23, with following steps: (1) Read values from database/Controller; (2) Encode data into binary in master file; (3) Send data using DNP3; (4) Decode data in RTDS Outstation; (5) Receive by RTDS model.

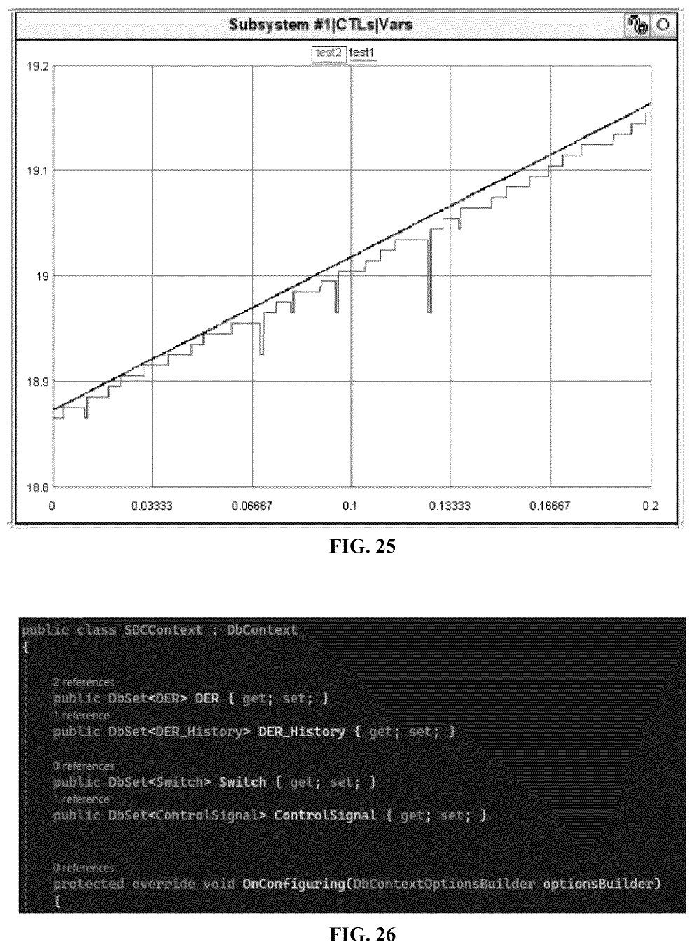

FIGS. 24 and 25 show the result of the encode/decode performance using sine wave and ladder wave, the black line is the data generated from RTDS, the red line represents the data received by the RTDS after the encoding and decoding process. Y-axis is the data value, the x value is the time, in milliseconds. The horizontal distance between the two lines at the same Y-axis height is the delay. Based on both charts, the delay is around 10 ms, which is good for SDC control.

### 6.3.4 SQL Server

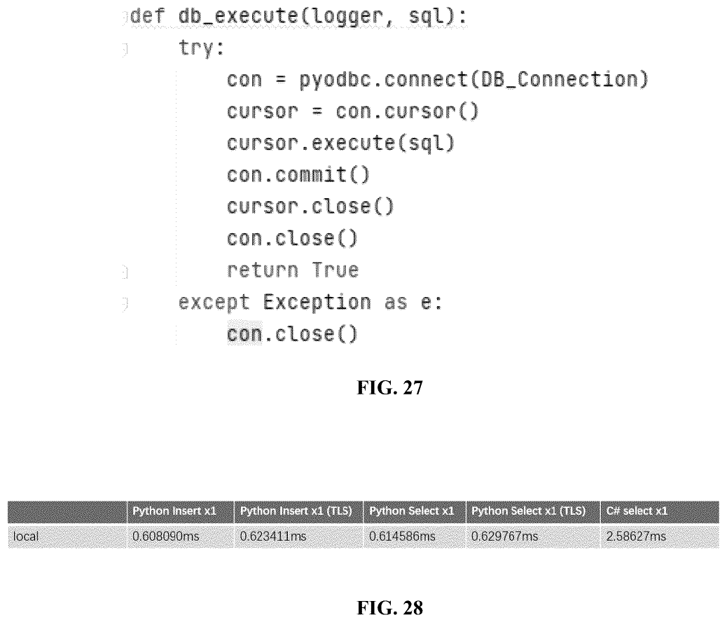

All the data is saved into the SQL database. C and python code is used to access the data. For C, EF Core was used to encapsulate the data access, like a code snippet shown in FIG. 26. For python, pyodbc was used to access the data. FIG. 27 shows a code example to execute a SQL query. The data access speed is fast in the local network. All queries can be done in less than 1 ms. The speed is shown in FIG. 28. It should be noted that in the database work was only provided with 15 loads, with this data constantly refreshed in real time, and since there is a need to compute/display the same set of data, there will not be any data query performance issue.

### 6.3.5 AI-Grid Control Function

All teams would require different algorithms to work upon the microgrid. All the programs would follow the similar steps like shown in the following: (1) Read input data from Database; (2) Compute AI-Grid functions; and (3) Save result data into the database.

### 6.4 Customization for Each Team

Each team would use different input, algorithms, refresh speed, output, the generic design would be followed and a separate workflow created for each team.

### 6.4.1 SDC

Nowadays, microgrid controllers are often embedded in specialized hardware such as PLC and DSP. The hardware-dependency and fit-and-forget design make it difficult and costly for micro-grid controllers to evolve and upgrade under frequent changes such as plug-and-play of microgrid components. Furthermore, different distributed energy resources in a microgrid require customized controllers, leading to long development cycles and high operational costs for deploying microgrid services. To tackle the challenges, a software-defined control (SDC) architecture for microgrid is devised, which virtualizes traditionally hardware-dependent microgrid control functions as software services decoupled from the underlying hardware infrastructure, fully resolving hardware dependence issues and enabling unprecedentedly low costs.

### Architecture:

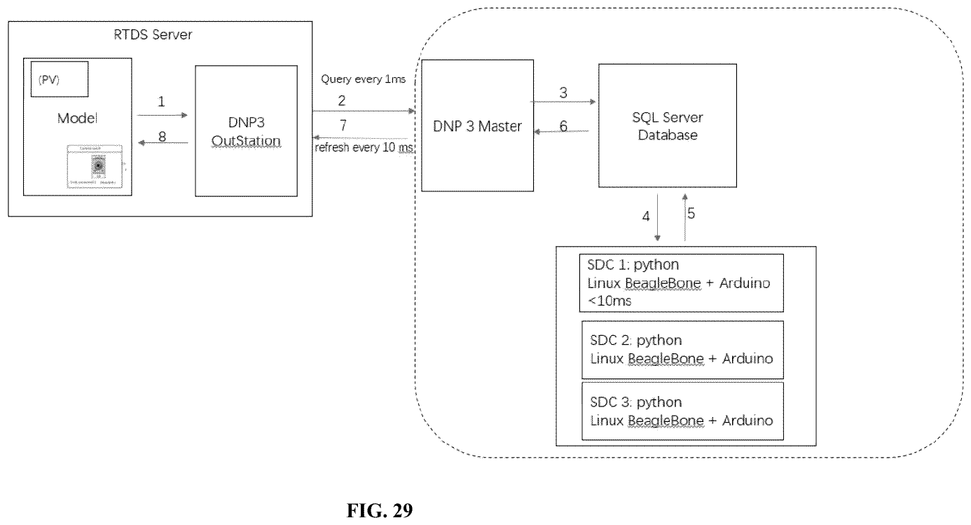

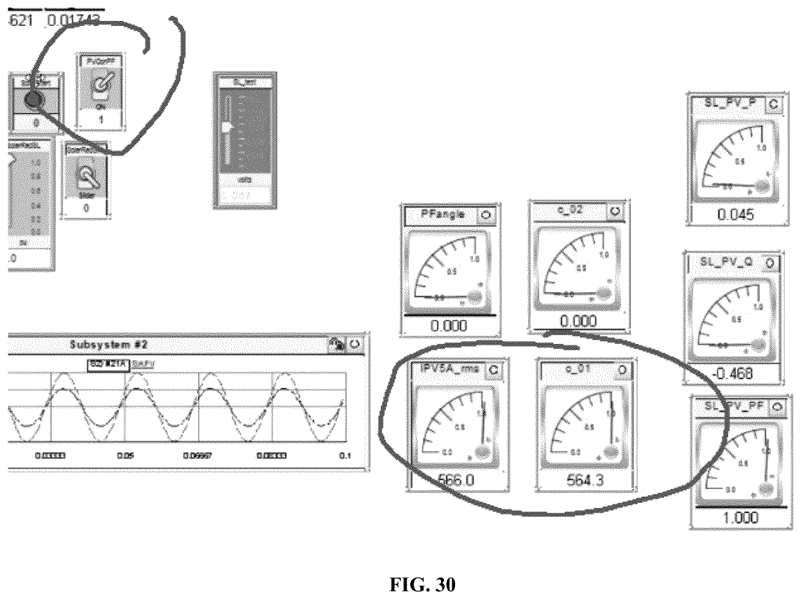

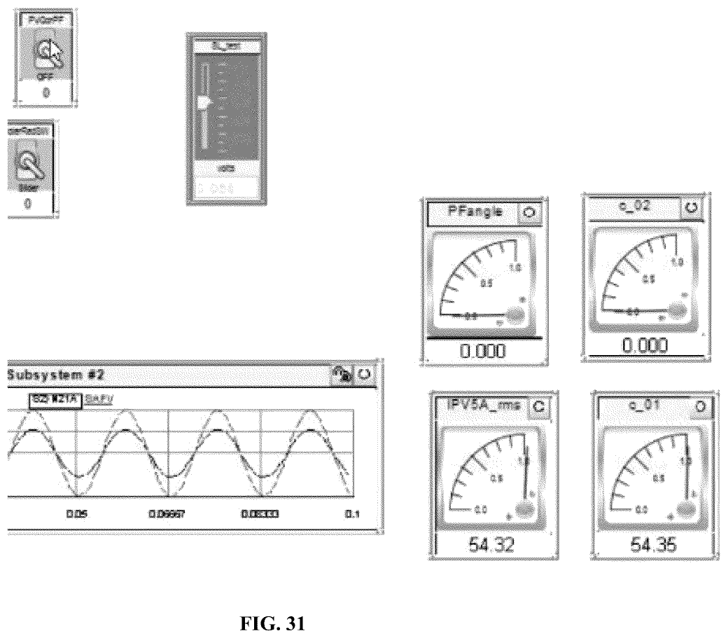

SDC was currently implemented using the following architecture as shown in FIG. 29, with the following steps: (1) Send PV data out using DNP3 outstation in RTDS; (2) Receive data using DNP3 master; (3) Save data into Database; (4) Run SDC code to get updated PV Control Value; (5) Save SDC control value computed value back to Database; (6) C program read value from database; (7) Send control value back to RTDS using DNP3 master; and (8) Receive value in RTDS using Outstation.

It should be noted that since SDC is mainly fast backend control, there is no need to display data onto the UI.

On the controller side, there shown above a PV controller, but the same idea can be easily expanded to other types of DER like diesel generator or battery. The SDC1, SDC2, SDC3 should be noted on the chart, so there can be multiple controllers on the server for different devices or different algorithms. This control can also be migrated to a Syndem/DSP device in the real environment if the control signal is harder to reach in the long distance.

A separate python project is created, the workflow for this python is shown: (1) Read active power, reactive power, etc. from Database Compute control signal values; (2) Save data into the database; and (3) Table 5. SDC python project workflow. Result: As can be seen from FIGS. 30 and 31, when the PV switch is turned on and off, the IPV5Aᵣms and the result c₀₁ values stay very close to each other, meaning that the control signal is computed fast and accurately enough for the control.

### 6.4.2 Power Flow

Power flow is used to compute the steady state of the power system, including voltage magnitudes and angles, the directions of branch flows. It is efficient and convenient to visualize the operational status on the platform.

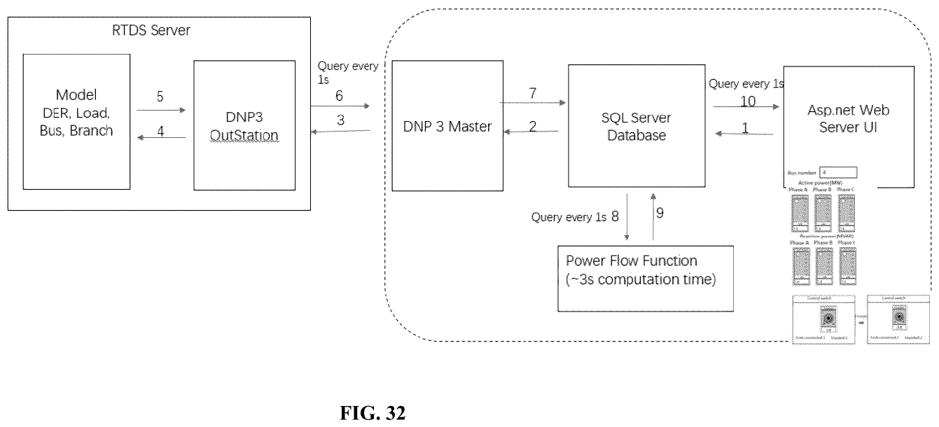

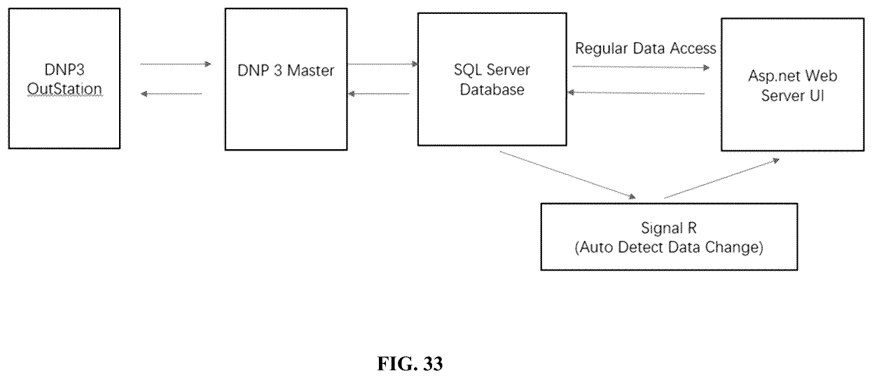

The architecture of the power flow is shown in FIGS. 32 and 33, wherein the following steps are shown: (1) Save updated load on/off values, island mode on/off from user input into database; (2) Send values back to RTDS using DNP3 master; (3) Receive data using DNP3 outstation; (4) Compute updated DER data in RTDS; (5) Send data using DNP3 Outstation; (6) Receive data using DNP3 Master; (7) Save data into Database; (8) Run Powerflow code to get updated power flow direction, bus data and branch data; (9) Save computed value back to Database; and (10) Update front end with database value.

The power flow code can be successfully run to get the update flow direction and bus voltage information.

### 6.4.3 Digital Twin User Interface

Background: Developing the user-interface for a digital twin of a microgrid system has several requirements. First, the data pipeline requires the collection of data from perhaps hundreds of sensing objects. Additionally, this collected sensor data must be presented to the user in near real-time. The system must also be able to show a representation of physical assets and allow the user to monitor them.

### Data Ingestion and Integration:

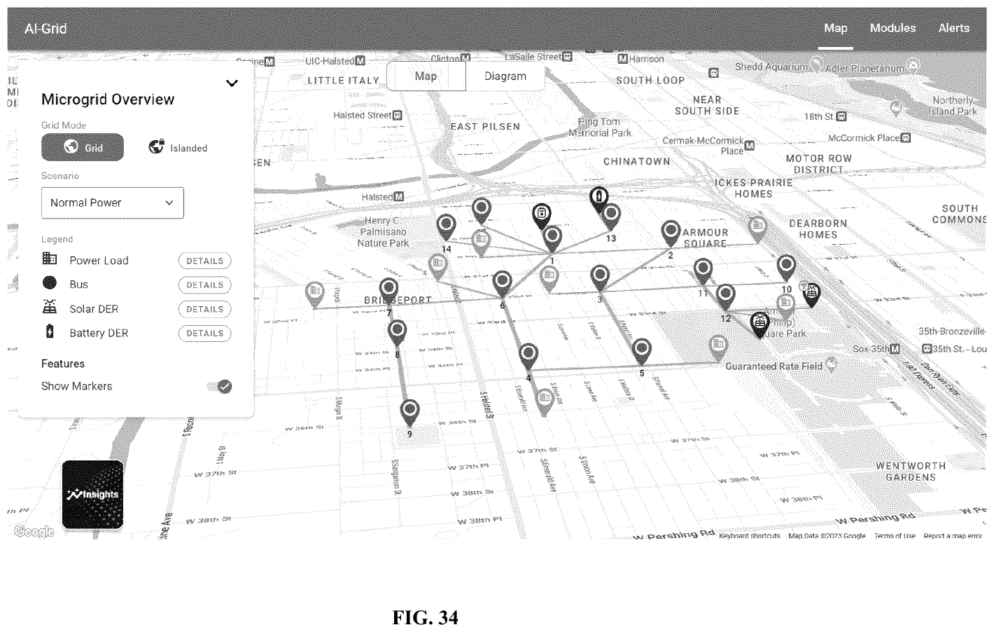

The data flow of the digital twin is expected to provide real-time data from multiple sensing devices. To achieve this, a publisher-subscriber data pipeline was created. Publisher-subscriber is a scalable messaging paradigm that allows a publisher to deliver messages to interested subscribers by sending messages as soon as they become available. As a result, subscribers do not have to periodically check if new data has become available, allowing for near real-time communication. The open-source SignaIR from the .NET ecosystem was chosen as the publisher-subscriber implementation. Data from various sensors is made available through DNP3 and as new data points are collected SignaIR publishes these changes as messages to interested subscribers. An overview of the AI-Grid platform (system) is shown in FIG. 34. A full diagram of the setup is provided below:

### User-Interface:

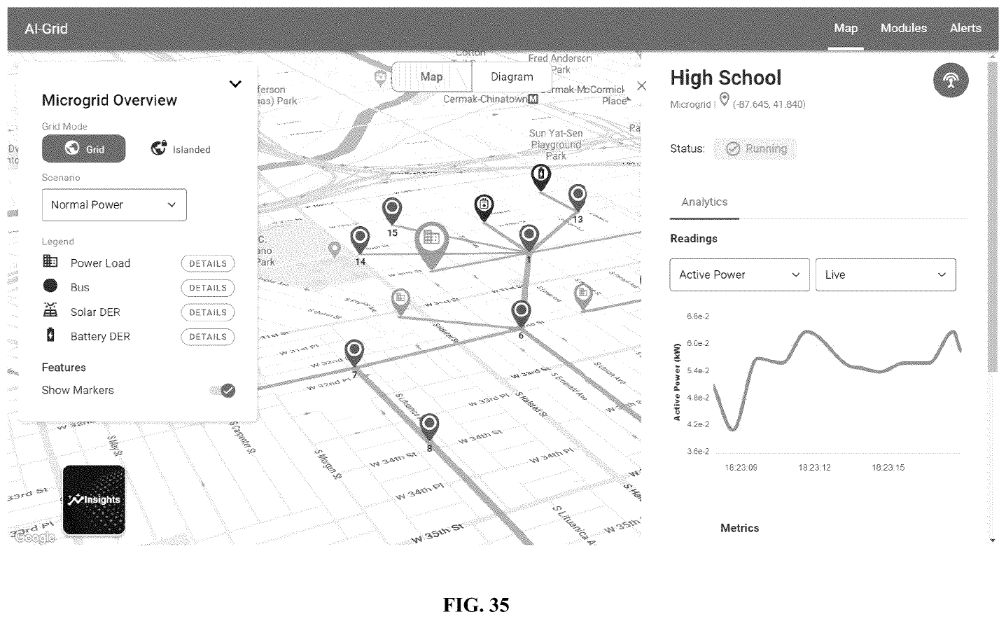

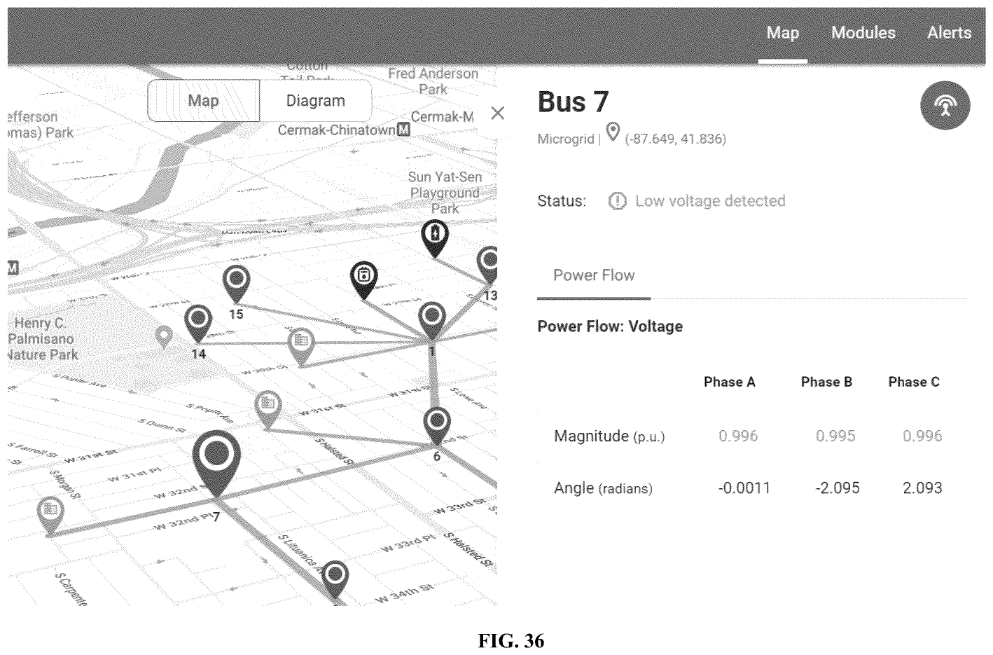

The user-interface overlays the assets of a microgrid on a map allowing an operator to see the geospatial layout of distributed energy resources (DER's), loads and buses, as shown in FIGS. 35 and 36. The map tiles are provided through the Google Maps Javascript API [6].

### Monitoring:

A key function of a digital twin is to allow remote monitoring of an existing physical system. Here each asset is represented on the map by a marker. When clicked, the marker expands to reveal the critical information regarding that asset. An example of an asset representing a high school is shown below.

As each asset has different critical data points to monitor, the supporting dashboard shows different visualizations depending on what is clicked. For example, when a bus is expanded, power flow readings are presented to the user.

### WebGL Visualizations:

WebGL is a JavaScript API for rendering both 2D and 3D visualizations. The Google map display grants access to the WebGL context. This allows for control of tilting the camera in three dimensions and properly occluding rendered objects.

To improve interpretability of visualizations, 3D WebGL graphics are used where appropriate. The deck.gl framework [7] was used for creating the 3D visualizations. For example, the following column visualization shows the voltage at each of the buses in a microgrid.

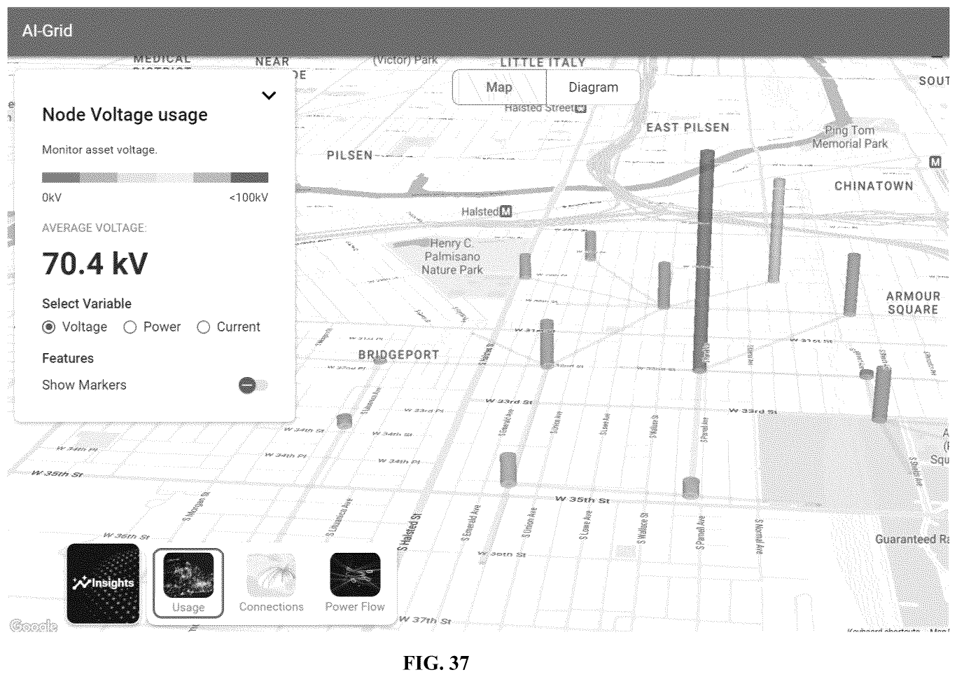

The magnitude of the voltage is represented by the color and height of the columns, as shown in FIG. 37. The geospatial location and scale of the largest bus voltage is more obvious with the 3D visualization than with a table of latitude/longitude locations and voltages. An important aspect in monitoring a microgrid is knowing the magnitude and flow direction of power throughout the network. Again, useful 3D exploratory visualizations can quickly reveal this information to the user as shown below.

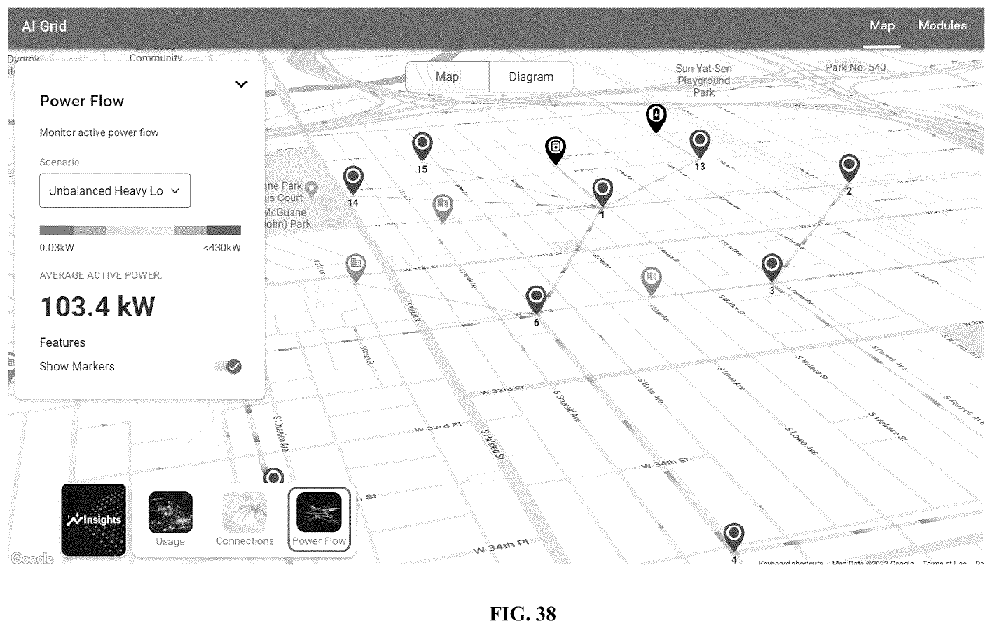

Here, the direction of the flow of power is indicated by animating particles traveling between different buses. The magnitude of active power of the flow is indicated by the color, with red being a high value and blue being a lower one see, as shown in FIG. 38.

One-line Diagram: To provide operators of the application with a more traditional view of the system, an equivalent one-line diagram representation of the system was created as well.

### 7. AI-GRID FOR GRID MODERNIZATION

There is further development of the AI Grid into a next-generation distribution/microgrid/building management system. It will further include advanced fault management control and optimization to enable enhanced distributed energy resources, electric vehicles and microgrid penetration without compromising reliability. It will feature SDN-based architectures and techniques to enable secure, reliable and fault-tolerant algorithms for resilient networked systems. It will provide reachability techniques to facilitate achieving provable resilience on the fly with high penetration of renewables. AI-Grid is deployed and it is demonstrated how the data-intensive, self-configurable management system enables resilient distribution grids, smart communities, and smart infrastructures for electric vehicles and distributed energy resource aggregations. It will be verified how AI-Grid will enable extreme renewable energy hosting and improve resilience against attacks, faults, and disasters in an affordable, lightweight, and secure way.

As a whole, the aim is to provide an interoperable and high-precision visualization software platform, which incorporates various AI functions and a real-time data stream processing engine with multiple sensing modalities and operation attributes. There is work being done with communications infrastructure solution providers which will assist infrastructure design and system deployment. Edge computing platform is being integrated to implement real-time monitoring and control solutions. Leveraging the expertise and resources of partners allows to minimize and mitigate risk and achieve deployment at scale.

### 8. EXERCISES

Consider a thermostat gradually increasing the room temperature to reach its target of 20° C. The current temperature is denoted by x. The control input u measures how much heat the radiator is emitting. The system dynamics is \dot{x}=f(x, u))=max(0, min(u, 2)). The BC is defined by g(x)=max((20−x)/10,0). The initial temperature is in the range 16° C. to 18° C.
1. There can be derived a barrier certificate for this system showing that it maintains a safe temperature between 16° C. and 22° C.

2. Using the approach in Section 5.3, there can be derived from the BaC a forward switching condition that ensures this property holds when an AC is used.
3. There can be designed a reward function for using the DDPG algorithm to train a neural controller to maintain the target room temperature of 20° C.
4. The proofs of Theorems 4 and 5 in Section 5.7.2 can be used as exercises in connection with proving these theorems. Hint: Proofs of Theorems 1 and 2 can be useful.

### 9. GENERAL COMPUTER SYSTEM CAPABLE OF PERFORMING DESCRIBED METHODS OR COMPUTER-BASED FUNCTIONS

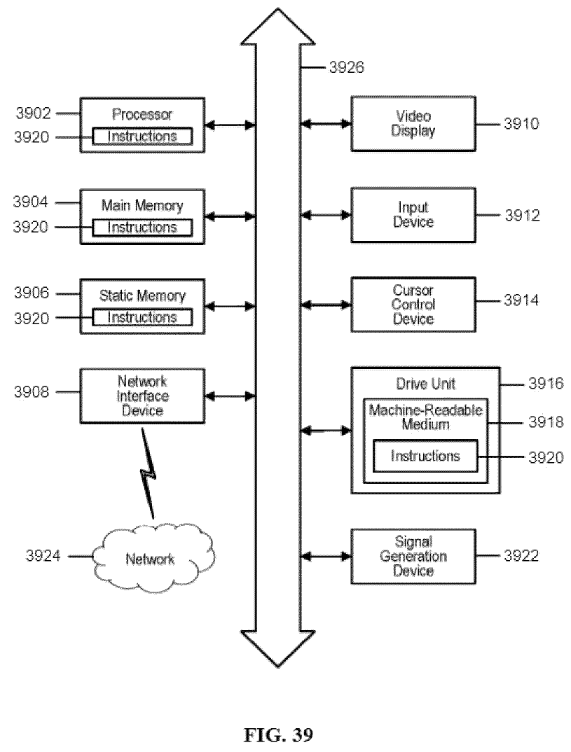

FIG. 39 is a block diagram of an illustrative embodiment of a general computer system 3900. The computer system 3900 can include a set of instructions that can be executed to cause the computer system 3900 to perform any one or more of the methods or computer based functions disclosed herein with reference to FIGS. 1-38. The computer system 3900, or any portion thereof, may operate as a standalone device or may be connected, e.g., using a network or other connection, to other computer systems or peripheral devices. For example, the computer system 3900 may be any one of the electronic components disclosed herein within the AI grid system.

The computer system 3900 may also be implemented as or incorporated into various devices, such as a personal computer (PC), a tablet PC, a personal digital assistant (PDA), a computing device or mobile device (e.g., smartphone), a palmtop computer, a laptop computer, a desktop computer, a communications device, a control system, a web appliance, or any other machine capable of executing a set of instructions (sequentially or otherwise) that specify actions to be taken by that machine. Further, while a single computer system 3900 is illustrated, the term “system” shall also be taken to include any collection of systems or sub-systems that individually or jointly execute a set, or multiple sets, of instructions to perform one or more computer functions.

As illustrated in FIG. 39, the computer system 3900 may include a processor 3902, e.g., a central processing unit (CPU), a graphics-processing unit (GPU), or both. Moreover, the computer system 3900 may include a main memory 3904 and a static memory 3906 that can communicate with each other via a bus 3926. As shown, the computer system 3900 may further include a video display unit 3910, such as a liquid crystal display (LCD), an organic light emitting diode (OLED), a flat panel display, a solid state display, or a cathode ray tube (CRT). Additionally, the computer system 3900 may include an input device 3912, such as a keyboard, and a cursor control device 3914, such as a mouse. The computer system 3900 can also include a disk drive (or solid state) unit 3916, a signal generation device 3922, such as a speaker or remote control, and a network interface device 3908.

In a particular embodiment or aspect, as depicted in FIG. 39, the disk drive (or solid state) unit 3916 may include a computer-readable medium 3918 in which one or more sets of instructions 3920, e.g., software, can be embedded. Further, the instructions 3920 may embody one or more of the methods or logic as described herein. In a particular embodiment or aspect, the instructions 3920 may reside completely, or at least partially, within the main memory 3904, the static memory 3906, and/or within the processor 3902 during execution by the computer system 3900. The main memory 3904 and the processor 1002 also may include computer-readable media.

In an alternative embodiment or aspect, dedicated hardware implementations, such as application specific integrated circuits, programmable logic arrays and other hardware devices, can be constructed to implement one or more of the methods described herein. Applications that may include the apparatus and systems of various embodiments or aspects can broadly include a variety of electronic and computer systems. One or more embodiments or aspects described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments or aspects, the methods described herein may be implemented by software programs tangibly embodied in a processor-readable medium and may be executed by a processor. Further, in an exemplary, non-limited embodiment or aspect, implementations can include distributed processing, component/object distributed processing, and parallel processing. Alternatively, virtual computer system processing can be constructed to implement one or more of the methods or functionality as described herein.

It is also contemplated that a computer-readable medium includes instructions 3920 or receives and executes instructions 3920 responsive to a propagated signal, so that a device connected to a network 3924 can communicate voice, video or data over the network 3924. Further, the instructions 3920 may be transmitted or received over the network 3924 via the network interface device 3908.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, example embodiment or aspect, the computer-readable medium can include a solid-state memory, such as a memory card or other package, which houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals, such as a signal communicated over a transmission medium. A digital file attachment to an e-mail or other self-contained information archive or set of archives may be considered a distribution medium that is equivalent to a tangible storage medium. Accordingly, any one or more of a computer-readable medium or a distribution medium and other equivalents and successor media, in which data or instructions may be stored, are included herein.

In accordance with various embodiments or aspects, the methods described herein may be implemented as one or more software programs running on a computer processor. Dedicated hardware implementations including, but not limited to, application specific integrated circuits, programmable logic arrays, and other hardware devices can likewise be constructed to implement the methods described herein. Furthermore, alternative software implementations including, but not limited to, distributed processing or component/object distributed processing, parallel processing, or virtual machine processing can also be constructed to implement the methods described herein.

It should also be noted that software that implements the disclosed methods may optionally be stored on a tangible storage medium, such as: a magnetic medium, such as a disk or tape; a magneto-optical or optical medium, such as a disk; or a solid state medium, such as a memory card or other package that houses one or more read-only (non-volatile) memories, random access memories, or other re-writable (volatile) memories. The software may also utilize a signal containing computer instructions. A digital file attachment to e-mail or other self-contained information archive or set of archives is considered a distribution medium equivalent to a tangible storage medium. Accordingly, a tangible storage medium or distribution medium as listed herein, and other equivalents and successor media, in which the software implementations herein may be stored, are included herein.

There have thus been described AI grid system and methods for AI-enabled, programmable, resilient, and networked microgrids. Although specific example embodiments or aspects have been described, it will be evident that various modifications and changes may be made to these embodiments or aspects without departing from the broader scope of the invention. Accordingly, the specification and drawings are to be regarded in an illustrative rather than a restrictive sense. The accompanying drawings that form a part hereof, show by way of illustration, and not of limitation, specific embodiments or aspects in which the subject matter may be practiced. The embodiments or aspects illustrated are described in sufficient detail to enable those skilled in the art to practice the teachings disclosed herein. Other embodiments or aspects may be utilized and derived therefrom, such that structural and logical substitutions and changes may be made without departing from the scope of this disclosure. This Detailed Description, therefore, is not to be taken in a limiting sense, and the scope of various embodiments or aspects is defined only by the appended claims, along with the full range of equivalents to which such claims are entitled.

Such embodiments or aspects of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments or aspects have been illustrated and described herein, it should be appreciated that any arrangement calculated to achieve the same purpose may be substituted for the specific embodiments or aspects shown. This disclosure is intended to cover any and all adaptations or variations of various embodiments or aspects. Combinations of the above embodiments or aspects, and other embodiments or aspects not specifically described herein, will be apparent to those of skill in the art upon reviewing the above description.

The Abstract is provided to comply with 37 CFR § 1.72(b) and will allow the reader to quickly ascertain the nature and gist of the technical disclosure. It is submitted with the understanding that it will not be used to interpret or limit the scope or meaning of the claims.

In the foregoing description of the embodiments or aspects, various features are grouped together in a single embodiment for the purpose of streamlining the disclosure. This method of disclosure is not to be interpreted as reflecting that the claimed embodiments or aspects have more features than are expressly recited in each claim. Rather, as the following claims reflect, inventive subject matter lies in less than all features of a single disclosed embodiment or aspect. Thus the following claims are hereby incorporated into the Detailed Description, with each claim standing on its own as a separate example embodiment or aspect. It is contemplated that various embodiments or aspects described herein can be combined or grouped in different combinations that are not expressly noted in the Detailed Description. Moreover, it is further contemplated that claims covering such different combinations can similarly stand on their own as separate example embodiments or aspects, which can be incorporated into the Detailed Description.

### 10. BIBLIOGRAPHY

[1] https://www.rtds.com/,
[2] https://www.microsoft.com/en-us/sql-server/sql-server-2022,
[3] https://stepfunc.io/products/libraries/dnp3/,
[4] https://github.com/stepfunc/dnp3,
[5] https://pypi.org/project/pyodbc/,
[6] https://developers.google.com/maps/documentation/javascript,
[7] https://deck.gl/,
[8] Martin Abadi et al. TensorFlow: Large-scale machine learning on heterogeneous systems, 2015. URL https://www.tensorflow.org/.
[9] Matthias Althoff. Reachability Analysis and its Application to the Safety Assessment of Autonomous Cars. PhD thesis, Technische Universität München, 2010.
[10] David Ofosu Amoateng, Mohamed Al Hosani, Mohamed Shawky Elmoursi, Konstantin Turitsyn, and James L. Kirtley. Adaptive voltage and frequency control of islanded multi-microgrids. IEEE Transactions on Power Systems, 33(4):4454-4465, 2018.
[11] M. Anghel, F. Milano, and A. Papachristodoulou. Algorithmic construction of Lyapunov functions for power system stability analysis. IEEE Transactions on Circuits and Systems I: Regular Papers, 60(9):2533-2546, 2013.
[12] Stanley Bak, Ashley Greer, and Sayan Mitra. Hybrid cyberphysical system verification with Simplex using discrete abstractions. In 16th IEEE Real-Time and Embedded Technology and Applications Symposium, pages 143-152, 2010.
[13] Stanley Bak, Karthik Manamcheri, Sayan Mitra, and Marco Caccamo. Sandboxing controllers for cyber-physical systems. In Proceedings of the IEEE/ACM International Conference on Cyber-Physical Systems (ICCPS 2011), pages 3-12, Apr 2011.
[14] Urs Borrmann, Li Wang, Aaron D. Ames, and Magnus Egerstedt. Control barrier certifi-cates for safe swarm behavior. In Magnus Egerstedt and Yorai Wardi, editors, Analysis and Design of Hybrid Systems, volume 48 of IFAC-PapersOnLine, pages 68-73. Elsevier, 2015.
[15] Francois Chollet et al. Keras, 2015. https://github.com/keras-team/keras.git.
[16] Edward De Brouwer, Jaak Simm, Adam Arany, and Yves Moreau. GRU-ODE-Bayes: Continuous modeling of sporadically-observed time series. In Advances in Neural Information Processing Systems 32, pages 7379-7390. 2019.
[17] Josep M. Guerrero, Juan C. Vasquez, Jose Matas, Luis Garcia de Vicuna, and Miguel Castilla. Hierarchical control of droop-controlled AC and DC microgrids—A general approach toward standardization. IEEE Transactions on Industrial Electronics, 58(1): 158-172, 2011.
[18] Taylor T. Johnson, Stanley Bak, Marco Caccamo, and Lui Sha. Real-time reachability for verified Simplex design. ACM Trans. Embedded Comput. Syst., 15(2):26:1-26:27, 2016.
[19] Diederik P. Kingma and Jimmy Ba. Adam: A method for stochastic optimization. In 3rd International Conference on Learning Representations, pages 1-15, 2015.
[20] S. Krishnamurthy, T. M. Jahns, and R. H. Lasseter. The operation of diesel gensets in a CERTS microgrid. In 2008 IEEE Power and Energy Society General Meeting—Conversion and Delivery of Electrical Energy in the 21st Century, pages 1-8, 2008.
[21] S. Kundu, S. Geng, S. P. Nandanoori, I. A. Hiskens, and K. Kalsi. Distributed barrier certificates for safe operation of inverter-based microgrids. In 2019 American Control Conference, pages 1042-1047, 2019.
[22] R. H. Lasseter and P. Paigi. Microgrid: A conceptual solution. In 2004 IEEE 35th Annual Power Electronics Specialists Conference (IEEE Cat. No.04CH37551), volume 6, pages 4285-4290, 2004.
[23] Timothy P. Lillicrap, Jonathan J. Hunt, Alexander Pritzel, Nicolas Heess, Tom Erez, Yuval Tassa, David Silver, and Daan Wierstra. Continuous control with deep reinforcement learning. In 4th International Conference on Learning Representations, pages 1-14, 2016.
[24] Tania B. Lopez-Garcia, Alberto Coronado-Mendoza, and Jose A. Dominguez-Navarro. Ar-tificial neural networks in microgrids: A review. Engineering Applications of Artificial Intelligence, 95(103894):1-14, 2020.
[25] Bipul Luitel and Ganesh Kumar Venayagamoorthy. Neural networks in RSCAD for intel-ligent real-time power system applications. In 2013 IEEE Power Energy Society General Meeting, pages 1-5, 2013.
[26] Bipul Luitel, Ganesh Kumar Venayagamoorthy, and Gabriel Oliveira. Developing neural networks library in RSCAD for real-time power system simulation. In 2013 IEEE Compu-tational Intelligence Applications in Smart Grid (CIASG 2013), pages 130-137, 2013.
[27] Usama Mehmood, Scott D. Stoller, Radu Grosu, Shouvik Roy, Amol Damare, and Scott A. Smolka. A distributed Simplex architecture for multi-agent systems. In Proceedings of the Symposium on Dependable Software Engineering: Theories, Tools and Applications (SETTA 2021), volume 13071 of Lecture Notes in Computer Science, pages 239-257. Springer, 2021.
[28] A. Mehrizi-Sani. Distributed control techniques in microgrids. In Magdi S. Mahmoud, editor, Microgrid: Advanced Control Methods and Renewable Energy System Integration, pages 43-62. Butterworth-Heinemann, 2017. ISBN 978-0-08-101753-1.
[29] Onyinyechi Nzimako and Athula Rajapakse. Real time simulation of a microgrid with multiple distributed energy resources. In International Conference on Cogeneration, Small Power Plants and District Energy (ICUE 2016), pages 1-6, 2016.
[30] Colm J. O'Rourke, Mohammad M. Qasim, Matthew R. Overlin, and James L. Kirtley. A geometric interpretation of reference frames and transformations: dq0, Clarke, and Park. IEEE Transactions on Energy Conversion, 34(4):2070-2083, 2019.
[31] Anay Pattanaik, Zhenyi Tang, Shuijing Liu, Gautham Bommannan, and Girish Chowdhary. Robust deep reinforcement learning with adversarial attacks, 2017.
[32] Dung Phan, Radu Grosu, Nils Jansen, Nicola Paoletti, Scott A. Smolka, and Scott D. Stoller. Neural Simplex architecture. In NASA Formal Methods Symposium, pages 97-114. Springer International Publishing, 2020.
[33] N. Pogaku, M. Prodanovic, and T. C. Green. Modeling, analysis and testing of autonomous operation of an inverter-based microgrid. IEEE Transactions on Power Electronics, 22(2): 613-625, 2007.
[34] Michael Poli, Stefano Massaroli, Clayton M. Rabideau, Junyoung Park, Atsushi Yamashita, Hajime Asama, and Jinkyoo Park. Continuous-depth neural models for dynamic graph prediction, 2021. URL https://arxiv.org/abs/2106.11581.
[35] Stephen Prajna. Barrier certificates for nonlinear model validation. Automatica, 42(1): 117-126, 2006.
[36] Stephen Prajna and Ali Jadbabaie. Safety verification of hybrid systems using barrier certificates. In Rajeev Alur and George J. Pappas, editors, Proceedings of the 7th Inter-national Workshop on Hybrid Systems: Computation and Control (HSCC 2004), volume 2993 of Lecture Notes in Computer Science, pages 477-492. Springer, 2004.
[37] Stephen Prajna, Ali Jadbabaie, and George J. Pappas. A framework for worst-case and stochastic safety verification using barrier certificates. IEEE Transactions on Automatic Control, 52(8):1415-1428, 2007.
[38] RTDS-Technologies-Inc. Power hardware-in-the-loop (PHIL). https://www.rtds.com/applications/power-hardware-in-the-loop/, 2022.
[39] Youngjoo Seo, Micha\ddot{ }el Defferrard, Pierre Vandergheynst, and Xavier Bresson. Structured sequence modeling with graph convolutional recurrent networks. In The 25th International Conference on Neural Information Processing, pages 362-373, 2018.
[40] D. Seto, B. Krogh, L. Sha, and A. Chutinan. The Simplex architecture for safe online control system upgrades. In Proceedings of the 1998 American Control Conference. ACC (IEEE Cat. No. 98CH36207), volume 6, pages 3504-3508, 1998.
[41] Lui Sha. Using simplicity to control complexity. IEEE Software, 18(4):20-28, 2001.
[42] Meng Sha, Xin Chen, Yuzhe Ji, Qingye Zhao, Zhengfeng Yang, Wang Lin, Enyi Tang, Qiguang Chen, and Xuandong Li. Synthesizing barrier certificates of neural network con-trolled continuous systems via approximations. In 2021 58th ACM/IEEE Design Automation Conference, pages 631-636, 2021.
[43] Kuang-Hsiung Tan, Faa-Jeng Lin, Cheng-Ming Shih, and Che-Nan Kuo. Intelligent control of microgrid with virtual inertia using recurrent probabilistic wavelet fuzzy neural network. IEEE Transactions on Power Electronics, 35(7):7451-7464, 2020.
[44] L. Wang, D. Han, and M. Egerstedt. Permissive barrier certificates for safe stabilization using sum-of-squares. In 2018 Annual American Control Conference, pages 585-590, 2018.
[45] Lizhi Wang, Yanyuan Qin, Zefan Tang, and Peng Zhang. Software-defined microgrid con-trol: The genesis of decoupled cyber-physical microgrids. IEEE Open Access Journal of Power and Energy, 7:173-182, 2020.
[46] Junxing Yang, Md. Ariful Islam, Abhishek Murthy, Scott A. Smolka, and Scott D. Stoller. A Simplex architecture for hybrid systems using barrier certificates. In Proceedings of the 36th International Conference on Computer Safety, Reliability, and Security (SAFECOMP 2017), volume 10488 of Lecture Notes in Computer Science, pages 117-131. Springer, 2017.
[47] Bing Yu, Haoteng Yin, and Zhanxing Zhu. Spatio-temporal graph convolutional networks: A deep learning framework for traffic forecasting. In Proceedings of he 27th International Joint Conference on Artificial Intelligence (IJCAI), 2018.
[48] Bing Yu, Haoteng Yin, and Zhanxing Zhu. ST-UNet: A spatio-temporal u-network for graph-structured time series modeling. arXiv, abs/1903.05631, 2019.
[49] Hengjun Zhao, Xia Zeng, Taolue Chen, and Zhiming Liu. Synthesizing barrier certificates using neural networks. In Proceedings of the 23rd International Conference on Hybrid Systems: Computation and Control (HSCC 2020), pages 1-11. Association for Computing Machinery, 2020.
[50] Qingye Zhao, Xin Chen, Yifan Zhang, Meng Sha, Zhengfeng Yang, Wang Lin, Enyi Tang, Qiguang Chen, and Xuandong Li. Synthesizing ReLU neural networks with two hidden layers as barrier certificates for hybrid systems. In Proceedings of the 24th International Conference on Hybrid Systems: Computation and Control (HSCC 2021), pages 1-11. As-sociation for Computing Machinery, 2021.
[51] Yang Zhou and Carl Ngai-Man Ho. A review on microgrid architectures and control methods. In 2016 IEEE 8th International Power Electronics and Motion Control Conference (IPEMC-ECCE Asia 2016), pages 3149-3156, 2016.

1. An artificial intelligence (AI) grid system for networked microgrids, the system comprising:
a processing device;
a memory storing instructions that, when executed by the processing device, perform one or more operations comprising:
neural reachability for dynamically verifying behavior of the microgrids;
neural ordinary differential equations net (ODE-Net) for modeling states associated with the microgrids;
barrier-based neural simplex for assuring runtime safety and control of neural controllers associated with the microgrids;
grid forming (GFM^{H}—Hamiltonian grid forming technology) for enabling one or more of passivity, stability, and scalability guarantees in the microgrids;
active fault management (AI-AFM) for providing federated learning to active fault management of the microgrids and/or inverter-based resources (IBRs), with cybersecurity assurance against one or more attacks and/or data poisoning;
neural dynamic state estimation for estimating the states of the microgrids using ODE-Net with application of Kalman filters;
traveling wave protection (AI-TWP) for providing neural network facilitated and internet-of-things (IoT) enabled processing of reflected traveling wave signals in a time-frequency domain; and
integration and operational visualization of the one or more operations, providing for visualization of an operational status of the grid system and statuses of the associated microgrids, and providing for execution and results of execution of the one or more operations.

2. An artificial intelligence (AI) grid method for networked microgrids, the method comprising performing one or more operations comprising:
neural reachability for dynamically verifying behavior of the microgrids;
neural ordinary differential equations net (ODE-Net) for modeling states associated with the microgrids;
barrier-based neural simplex for assuring runtime safety and control of neural controllers associated with the microgrids;
grid forming (GFM^{H}—Hamiltonian grid forming technology) for enabling one or more of passivity, stability, and scalability guarantees in the microgrids;
active fault management (AI-AFM) for providing federated learning to active fault management of the microgrids and/or inverter-based resources (IBRs), with cybersecurity assurance against one or more attacks and/or data poisoning;
neural dynamic state estimation for estimating the states of the microgrids using ODE-Net with application of Kalman filters;
traveling wave protection (AI-TWP) for providing neural network facilitated and internet-of-things (IoT) enabled processing of reflected traveling wave signals in a time-frequency domain; and
integration and operational visualization of the one or more operations, providing for visualization of an operational status of the grid system and statuses of the associated microgrids, and providing for execution and results of execution of the one or more operations.
